(19) United States
(12) Patent Application Publication
(10) Pub. No.: US 2024/0174552 A1
(43) Pub. Date: May 30, 2024

(54) LITHIUM ALUMINOSILICATE GLASSES FOR CHEMICAL STRENGTHENING

(71) Applicant: CORNING INCORPORATED, CORNING, NY (US)

(72) Inventors: Timothy Michael Gross, Painted Post, NY (US); Alexander I. Priven, Chungchongnam-do (KR); Jingshi Wu, Painted Post, NY (US)

(21) Appl. No.: 18/517,672

(22) Filed: Nov. 22, 2023

Related U.S. Application Data
(60) Provisional application No. 63/428,176, filed on Nov. 28, 2022.

(51) Int. Cl. C03C 3/097; C03C 3/11

(52) U.S. Cl. CPC C03C 3/097; C03C 3/11

(57) ABSTRACT

Glass compositions include one or more of silica (SiO₂), alumina (Al₂O₃), sodium oxide (Na₂O), lithium oxide (Li₂O), magnesia (MgO), phosphorus oxide (P₂O₅) and zinc oxide (ZnO) as essential components and may optionally include boron oxide (B₂O₃), calcium oxide (CaO), K₂O (potassium oxide), Alk₂O (Alk₂O), REₘOₙ (REₘOₙ), TiO₂ (titania) and other components.

This application claims the benefit of priority of U.S. Provisional Application Ser. No. 63/428,176 filed on Nov. 28, 2022, the content of which is relied upon and incorporated herein by reference in its entirety.

### FIELD

The present specification generally relates to glass compositions suitable for use as cover glass for electronic devices. More specifically, the present specification is directed to lithium-containing aluminosilicate glasses that may be formed into cover glass for electronic devices and may be strengthened by ion exchange strengthening.

### BACKGROUND

The mobile nature of portable devices, such as smart phones, tablets, portable media players, personal computers, and cameras, makes these devices particularly vulnerable to accidental dropping on hard surfaces, such as the ground. These devices typically incorporate cover glasses, which may become damaged upon impact with hard surfaces. In many of these devices, the cover glasses function as display covers, and may incorporate touch functionality, such that use of the devices is negatively impacted when the cover glasses are damaged.

One conventional way to strengthen glass articles, such as cover glass for portable electronics, is by ion exchange strengthening processes. In ion exchange strengthening processes, the glass article is placed in a molten salt bath. The salt in the molten salt bath generally comprises alkali metal cations that are larger than the alkali metal components in the glass article. For example, if the glass article comprises sodium, then the salt in the molten salt bath will generally comprise potassium or larger alkali cations. During the ion exchange chemical strengthening process, the process conditions—such as temperature, pressure, etc.—are such that the cations from the salt bath replace (or are exchanged for) the alkali metals in the glass article. This exchange of smaller ions in the glass article for the larger ions in the salt bath results in a stiffening of the glass matrix that causes a compressive stress in the layer of the glass article where the ions are exchanged. This compressive stress results in a strengthened portion of the glass article that is more resistant to damage than glass articles that do not have compressive stress layers.

However, balancing the alkali metals traditional needed to perform ion exchange processes in a glass article with the other components of a glass article to balance the properties of the glass article is difficult. For example, increasing the amount of alkali metals in the glass composition may improve the ion exchangeability of the glass article, but it may result in other, less desirable properties. Accordingly, a need exists for glasses that can be strengthened, such as by ion exchange, and that have the mechanical properties that allow them to be formed as desired.

### SUMMARY

According to an embodiment of the present disclosure, a glass comprises a plurality of components, the glass having a composition of the components comprising greater than or equal to 60.0 mol. % and less than or equal to 70.0 mol. % SiO₂, greater than or equal to 5.0 mol. % and less than or equal to 20.0 mol. % Al₂O₃, greater than or equal to 1.0 or 1.2 mol. % and less than or equal to 4.0 mol. % MgO, greater than or equal to 0.5 mol. % and less than or equal to 10.0 mol. % Li₂O, greater than or equal to 0.45 mol. % and less than or equal to 6 mol. % P₂O₅, greater than or equal to 0.0 mol. % and less than or equal to 15.0 mol. % Na₂O, greater than or equal to 0.0 mol. % and less than or equal to 5.0 mol. % B₂O₃, greater than or equal to 0.0 mol. % and less than or equal to 1.0 mol. % ZnO, greater than or equal to 0.0 mol. % and less than or equal to 0.5 mol. % K₂O, less than or equal to 16.0 mol. % Alk₂O and greater than or equal to 0.0 mol. % and less than or equal to 1.5 mol. % REₘOₙ and wherein the composition of the components satisfies the conditions: 0.85≤Alk₂O/Al₂O₃ [mol. %]≤1.2, where chemical formulas mean the content of corresponding components in the glass, Alk₂O is a total sum of alkali metal oxides, and REₘOₙ is a total sum of rare earth metal oxides.

According to another embodiment of the present disclosure, a glass comprises a plurality of components, the glass having a composition of the components comprising greater than or equal to 58.0 mol. % and less than or equal to 69.9 mol. % SiO₂, greater than or equal to 3.0 mol. % and less than or equal to 10.0 mol. % Na₂O, greater than or equal to 3 mol. % and less than or equal to 7.95 mol. % Li₂O, greater than or equal to 1.0 mol. % and less than or equal to 20.0 mol. % Al₂O₃, greater than or equal to 0.0 mol. % and less than or equal to 4.8 mol. % MgO, greater than or equal to 0.0 mol. % and less than or equal to 4.0 mol. % ZnO, greater than or equal to 0.0 mol. % and less than or equal to 2.5 mol. % CaO, greater than or equal to 0.0 mol. % and less than or equal to 1.0 mol. % TiO₂, greater than or equal to 0.0 mol. % and less than or equal to 1.0 mol. % ZrO₂, greater than or equal to 0.0 mol. % and less than or equal to 0.5 mol. % SnO₂, greater than or equal to 0.0 mol. % and less than or equal to 0.5 mol. % BaO, greater than or equal to 0.0 mol. % and less than or equal to 0.5 mol. % K₂O, greater than or equal to 9.0 mol. % and less than or equal to 17.5 mol. % Alk₂O, greater than or equal to 0.0 mol. % and less than or equal to 1.5 mol. % REₘOₙ, a sum of Li₂O+Na₂O is greater than or equal to 12.0 mol. % and less than or equal to 17.5 mol. %, wherein the composition of the components satisfies the conditions: 0.50≤Li₂O/Alk₂O [mol. %]≤0.55 and 0.85≤Alk₂O/Al₂O₃[mol. %]≤1, and wherein the glass has RO balance parameter, P_{RO} that is greater than or equal to −2 and less than or equal to 2 and wherein the glass satisfies the conditions: Pₒₓ−(1.5+P_{RO})<0.000, where P_{RO} is a value of RO balance parameter, calculated from the glass composition in terms of mol. % of the components according to the Formula (II):

P_{RO}=(MgO+CaO+ZnO)−(B₂O₃+P₂O₅), (II)

Pₒₓ is a value of oxygen balance parameter, calculated from the glass composition in terms of mol. % of the components according to the Formula (I):

Pₒₓ=(Alk₂O+RO)−(Al₂O₃+P₂O₅), (I)

where chemical formulas mean the content of corresponding components in the glass, Alk₂O is a total sum of alkali metal oxides, and REₘOₙ is a total sum of rare earth metal oxides.

These and other aspects, objects, and features of the present disclosure will be understood and appreciated by those skilled in the art upon studying the following specification, claims, and appended drawings.

### BRIEF DESCRIPTION OF THE DRAWINGS

FIG. 1A and FIG. 1B are stress profiles of some Exemplary Glasses after two-step ion exchange.

FIG. 2 is a plot illustrating the relationship between the RO balance parameter P_{RO} and the oxygen balance parameter Pₒₓ for some Comparative Glasses and some Exemplary Glasses according to an embodiment of the present disclosure.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including, without limitation, matters of logic with respect to arrangement of steps or operational flow; plain meaning derived from grammatical organization or punctuation; the number or type of embodiments described in the specification.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those skilled in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The term “formed from” can mean one or more of comprises, consists essentially of, or consists of. For example, a component that is formed from a particular material can comprise the particular material, consist essentially of the particular material, or consist of the particular material.

The terms “free” and “substantially free” are used interchangeably herein to refer to an amount and/or an absence of a particular component in a glass composition that is not intentionally added to the glass composition. It is understood that the glass composition may contain traces of a particular constituent component as a contaminant or a tramp in an amount of less than 0.10 mol. %.

As used herein, the term “tramp”, when used to describe a particular constituent component in a glass composition, refers to a constituent component that is not intentionally added to the glass composition and is present in an amount of less than 0.10 mol. %. Tramp components may be unintentionally added to the glass composition as an impurity in another constituent component and/or through migration of the tramp component into the composition during processing of the glass composition.

Unless otherwise specified, the term “glass” is used to refer to a glass made from a glass composition disclosed herein.

The symbol “*” means multiplication when used in any formula herein.

Reference will now be made in detail to alkali aluminosilicate glasses according to various embodiments. Alkali aluminosilicate glasses have good ion exchangeability, and chemical strengthening processes have been used to achieve high strength and high toughness properties in alkali aluminosilicate glasses. Lithium aluminosilicate glasses are highly ion exchangeable glasses. The substitution of Al₂O₃ into the silicate glass network increases the interdiffusivity of monovalent cations during ion exchange. By chemical strengthening in a molten salt bath (e.g., KNO₃ or NaNO₃), glasses with high strength, high toughness, and high indentation cracking resistance can be achieved.

Chemical strengthening, such as ion exchange strengthening, results in a compression stress layer in in the glass article, as described above. To increase this compressive stress, relaxation of the glass should be minimized. Glass compositions having a high annealing point and a high strain point can minimize relaxation and, thereby, increase the compressive stress of the glass article. High annealing and strain points may be achieved by forming a glass with high viscosity at low temperatures.

To improve other mechanical properties, such as Young's modulus and fracture toughness, components such as alumina (Al₂O₃) may be added to the glass composition. Also, to form the glass articles using conventional forming methods, the 200 Poise temperature of the glass composition should be relatively low. In addition, a low liquidus temperature may be needed to keep the glass composition from crystallizing when formed into a ribbon or article. It is difficult to formulate a glass composition that achieves all of these performance characteristics and that can be easily and effectively strengthened by ion exchange processes. For example, attempts to reduce the 200 Poise temperature can also reduce the annealing and strain points and liquidus viscosity of the glass composition. Likewise, attempts to add more lithium to a glass composition-which can improve the effectiveness of the ion exchange process-can result in raising the liquidus temperature, and adding too much alumina to improve mechanical properties can result in higher liquidus and melting temperatures.

Accordingly, embodiments of glass compositions and articles provided in this specification provide glass compositions that have relatively high lithium content and low content of other alkali metals. These glass compositions can be melted at relatively low temperatures that are compatible with conventional refractories, are stable at high temperatures-as shown by high strain and annealing points, have desirable mechanical properties, and have a relatively high liquidus viscosity.

As used herein: the term “softening point” refers to the temperature at which the viscosity of the glass composition is 107.6 poise; the term “annealing point” refers to the temperature determined according to ASTM C598-93, at which the viscosity of a glass of a given glass composition is approximately 1013.2 poise; the terms “strain point” and “Tstrain” refer to the temperature determined according to ASTM C598-93, at which the viscosity of a glass at a given glass composition is approximately 1014.7 poise; the term “liquidus temperature” refers to the temperature above which the glass composition is completely liquid with no crystallization of constituent components of the glass; the term “liquidus viscosity” refers to the viscosity of the glass composition at the liquidus temperature of the glass composition; the term “coefficient of thermal expansion” or “CTE” refers to the coefficient of linear thermal expansion of the glass composition over a temperature range from room temperature (RT) to 300° C.

After the batch materials are melted, it is desirable avoid crystallization when forming a glass sheet, ribbon, or other articles from the said melt. For glass-forming substances, the main numerical characteristic of the crystallization process is the liquidus temperature (TL), that specifies the minimum temperature above which a material is completely liquid, and the maximum temperature at which crystals can co-exist with the melt in thermodynamic equilibrium. This property is measured by the gradient method. This method conforms to ASTM C829-81 Standard Practices for Measurement of Liquidus Temperature of Glass. Accordingly, the glass forming process normally takes place at the temperature higher than TL. On the other hand, the liquidus viscosity of the glass composition can be used to determine which forming processes that can be used to make glass into a sheet is determined by the liquidus viscosity. The greater the liquidus viscosity the more forming processes will be compatible with the glass. Since glass viscosity decreases exponentially with temperature, it is desirable to keep the liquidus temperature as low as possible to maximize the viscosity at the liquidus. For float processing the glass composition generally has a liquidus viscosity of at least 10 kP, and the fusion process requires a liquidus viscosity of at least 50 kP, such as at least 100 kP, or at least 500 kP. For other processes, such as hot pressing, twin-rollers technique, etc. the viscosity value may be considerably lower. For example, for hot pressing that is used on occasion in optical industry, a liquidus viscosity of 10 to 20 poises may be satisfactory.

Compressive stress (including surface CS) after ion exchange was measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured at 546.1 nm according to Procedure C (Glass Disc Method) described in ASTM standard C770-16, entitled “Standard Test Method for Measurement of Glass Stress-Optical Coefficient”.

When characterizing the ranges of quantities, unless otherwise specified, the figures are assumed to contain the uncertainty that is equal to a half of a unit of the last significant digit specified in the claim. Herein, the term “last significant digit” means the last non-zero digit in the case when a decimal point is not presented, or the last digit, zero or non-zero, if a decimal point is presented. In particular: in the number “1650” (without decimal point) contains three significant digits (“1”, “6” and “5”), the last significant digit is the digit “5”, which presents tens, which means that the uncertainty is a half of ten, or ±5; accordingly, this number (“1650”) should be interpreted as “1650±5”, or as “greater than or equal to 1645” (if it presents the lower limit of a range), or “less than or equal to 1655” (if it presents a higher limit of a range); in the number “1.50” (with decimal point) the last significant digit is the last digit of the number, which is “0”, which presents hundredths, which means that the uncertainty is a half of one hundredth (0.005), and within the said uncertainty, the number “1.50” should be interpreted as “1.50±0.005”, or as “greater than or equal to 1.495” (if it presents a higher limit of a range) or “less than or equal to 1.505” (if it presents a lower limit of a range).

Specifically for the concentration ranges specified throughout the document, considering unavoidable uncertainty of such data that comes from the nature of the data (such as volatilization of species when melting in the case if the composition of glass is specified by batch, or uncertainty of chemical analysis if a composition is specified by analysis), it is assumed, unless otherwise specified, that the uncertainty of the such figures is ±0.05 mol. % if the value is greater than or equal to 0.5 mol. %, and ±10% of the value if the value is less than 0.5 mol. %. For example, for a value of 15.3 mol. % (which is greater than 0.5 mol. %) it is assumed that the uncertainty is ±0.05 mol. %; for a value of 0.40 mol. % (less than 0.5 mol. %) it is assumed that the uncertainty is ±10% of this value, which means ±0.04 mol. %.

Glass composition may include silica (SiO₂). According to embodiments, the main glass-forming component is silica (SiO₂), which is the largest constituent of the composition and, as such, is the primary constituent of the resulting glass network. Without being bound to theory, SiO₂ enhances the chemical durability of the glass and, in particular, the resistance of the glass composition to decomposition in acid and the resistance of the glass composition to decomposition in water. If the content of SiO₂ is too low, the chemical durability and chemical resistance of the glass may be reduced and the glass may be susceptible to corrosion. Accordingly, a high SiO₂ concentration is generally desired in embodiments. However, if the content of SiO₂ is too high, the formability of the glass may be diminished as higher concentrations of SiO₂ may increase the difficulty of melting the glass which, in turn, adversely impacts the formability of the glass. In embodiments, the glass composition may contain silica (SiO₂) in an amount from greater than or equal to 58.0 mol. % to less than or equal to 73.0 mol. % and all ranges and sub-ranges between the foregoing values. In some embodiments, the glass composition may contain SiO₂ in an amount greater than or equal to 58.0 mol. %, greater than or equal to 60.0 mol. %, greater than or equal to 62.0 mol. %, greater than or equal to 62.75 mol. %, greater than or equal to 63.0 mol. %, greater than or equal to 67.0 mol. %, greater than or equal to 67.5 mol. %, greater than or equal to 69.0 mol. %, or greater than or equal to 71.0 mol. %. In some other embodiments, the glass composition may contain SiO₂ in an amount less than or equal to 73.0 mol. %, less than or equal to 71.0 mol. %, less than or equal to 70.0 mol. %, less than or equal to 69.9 mol. %, less than or equal to 69.5 mol. %, less than or equal to 69.0 mol. %, less than or equal to 68.5 mol. %, less than or equal to 68.0 mol. %, less than or equal to 67.5 mol. %, less than or equal to 67.0 mol. %, or less than or equal to 60.0 mol. %. In some more embodiments, the glass composition may contain SiO₂ in an amount greater than or equal to 58.0 mol. % and less than or equal to 69.9 mol. %, greater than or equal to 60.0 mol. % and less than or equal to 70.0 mol. %, greater than or equal to 62.0 mol. % and less than or equal to 69.5 mol. %, greater than or equal to 62.75 mol. % and less than or equal to 68.5 mol. %, greater than or equal to 62.87 mol. % and less than or equal to 67.56 mol. %, greater than or equal to 58.0 mol. % and less than or equal to 73.0 mol. %, greater than or equal to 60.0 mol. % and less than or equal to 67.0 mol. %, greater than or equal to 62.0 mol. % and less than or equal to 67.0 mol. %, greater than or equal to 62.75 mol. % and less than or equal to 73.0 mol. %, greater than or equal to 62.75 mol. % and less than or equal to 67.0 mol. %, greater than or equal to 67.0 mol. % and less than or equal to 73.0 mol. %, greater than or equal to 67.0 mol. % and less than or equal to 67.5 mol. %.

Glass composition may include boron oxide (B₂O₃). Boron oxide (B₂O₃) is a flux which may be added to glass compositions to reduce the viscosity of the glass at a given temperature (e.g., the temperature corresponding to the viscosity of 200 poise or a 200 P temperature, at which glass is melted and which is usually the highest temperature in the glass melting furnace), thereby improving the quality and formability of the glass. At high concentrations, such as greater than or equal to about 10 mol %, boron oxide may suppress the crystallization of mullite. The presence of B₂O₃ may also improve damage resistance of the glass made from the glass composition. However, it has been found that additions of B₂O₃ may significantly decrease the diffusivity of sodium and potassium ions in the glass compositions, which, in turn, adversely impacts the ion exchange performance of the resultant glass. In particular, it has been found that addition of B₂O₃ may increase the time required to achieve a given depth of layer in the glass relative to glass compositions which are boron free. The addition of B₂O₃ may also increase the temperature at which ion exchange is conducted in order to achieve an ion exchange rate necessary to reach a target depth of layer in the glass in a given duration of time. Accordingly, the content of boron oxide is preferably limited, or glass compositions may be substantially free of B₂O₃. In embodiments, the glass composition may contain boron oxide (B₂O₃) in an amount from greater than or equal to 0.0 mol. % to less than or equal to 10.0 mol. % and all ranges and sub-ranges between the foregoing values. In some embodiments, the glass composition may contain B₂O₃ in an amount greater than or equal to 0.0 mol. %, greater than or equal to 0.4 mol. %, greater than or equal to 0.8 mol. %, greater than or equal to 1.0 mol. %, greater than or equal to 5.0 mol. %, greater than or equal to 7.0 mol. %, greater than or equal to 8.0 mol. %, or greater than or equal to 9.0 mol. %. In some other embodiments, the glass composition may contain B₂O₃ in an amount less than or equal to 10.0 mol. %, less than or equal to 9.0 mol. %, less than or equal to 8.0 mol. %, less than or equal to 7.0 mol. %, less than or equal to 5.0 mol. %, less than or equal to 4.6 mol. %, or less than or equal to 4.0 mol. %. In some more embodiments, the glass composition may contain B₂O₃ in an amount greater than or equal to 0.0 mol. % and less than or equal to 5.0 mol. %, greater than or equal to 0.4 mol. % and less than or equal to 4.6 mol. %, greater than or equal to 0.8 mol. % and less than or equal to 4.0 mol. %, greater than or equal to 0.95 mol. % and less than or equal to 3.6 mol. %, greater than or equal to 0.0 mol. % and less than or equal to 10.0 mol. %, greater than or equal to 0.0 mol. % and less than or equal to 4.0 mol. %, greater than or equal to 0.4 mol. % and less than or equal to 4.0 mol. %, greater than or equal to 1.0 mol. % and less than or equal to 10.0 mol. %, greater than or equal to 1.0 mol. % and less than or equal to 4.0 mol. %, greater than or equal to 5.0 mol. % and less than or equal to 7.0 mol. %. Preferably, the composition contains B₂O₃ in an amount greater than or equal to 0.4 mol %.

Glass composition may include phosphorus oxide (P₂O₅). The presence of phosphorus oxide (P₂O₅) increases the liquidus viscosity of the glass compositions by suppressing the crystallization of mullite, spodumene, and some other species (e.g., spinel) from the glass-forming melts., When Al₂O₃ (mol %) is greater than R₂O (mol %)+RO (mol %) by more than about 1 mol %. The presence of P₂O₅ in the glass composition compensates the excess Al₂O₃ by decreasing the liquidus temperature, thus increasing the liquidus viscosity of the glass composition. The addition of P₂O₅ allows reaching the positive values of Al₂O₃—R₂O—RO up to about 5.0 mol % without significant deterioration of the liquidus viscosity. In embodiments, the glass composition may contain phosphorus oxide (P₂O₅) in an amount from greater than or equal to 0.0 mol. % to less than or equal to 10.0 mol. % and all ranges and sub-ranges between the foregoing values. In some embodiments, the glass composition may contain P₂O₅ in an amount greater than or equal to 0.0 mol. %, greater than or equal to 0.3 mol. %, greater than or equal to 0.4 mol. %, greater than or equal to 0.8 mol. %, greater than or equal to 1.0 mol. %, greater than or equal to 1.6 mol. %, greater than or equal to 5.0 mol. %, greater than or equal to 7.0 mol. %, greater than or equal to 8.0 mol. %, or greater than or equal to 9.0 mol. %. In some other embodiments, the glass composition may contain P₂O₅ in an amount less than or equal to 10.0 mol. %, less than or equal to 9.0 mol. %, less than or equal to 8.0 mol. %, less than or equal to 7.0 mol. %, less than or equal to 6.0 mol. %, less than or equal to 5.0 mol. %, less than or equal to 4.0 mol. %, less than or equal to 3.7 mol. %, less than or equal to 3.3 mol. %, or less than or equal to 2.3 mol. %. In some more embodiments, the glass composition may contain P₂O₅ in an amount greater than or equal to 0.0 mol. % and less than or equal to 4.0 mol. %, greater than or equal to 0.3 mol. % and less than or equal to 4.0 mol. %, greater than or equal to 0.4 mol. % and less than or equal to 3.7 mol. %, greater than or equal to 0.45 mol. % and less than or equal to 6.0 mol. %, greater than or equal to 0.8 mol. % and less than or equal to 3.3 mol. %, greater than or equal to 1.0 mol. % and less than or equal to 4.0 mol. %, greater than or equal to 1.62 mol. % and less than or equal to 2.29 mol. %, greater than or equal to 0.0 mol. % and less than or equal to 10.0 mol. %, greater than or equal to 0.0 mol. % and less than or equal to 2.3 mol. %, greater than or equal to 1.0 mol. % and less than or equal to 2.3 mol. %, greater than or equal to 1.6 mol. % and less than or equal to 2.3 mol. %, greater than or equal to 5.0 mol. % and less than or equal to 6.0 mol. %.

Glass composition may include alkali metal oxides (Alk₂O). The glass compositions of the present disclosure contain, at least, some amount of alkali metal oxides, preferably Li₂O and Na₂O, or only Li₂O.

Alkali metal oxides, and especially Li₂O, may enable the use of ion exchange processes to provide high ion exchange stress in the glass.

Other alkalis, such as K₂O, Rb₂O and Cs₂O, may also be presented in the glass compositions, according to some embodiments. These alkalis may reduce the liquidus temperature and increase the liquidus viscosity, then preserving the glass forming melt from crystallization at high temperatures. However, these components generate undesirable effects, such as increasing the density, reducing the elastic moduli and fracture toughness, decreasing the compressive stress in an exchanged layer, etc., at low concentrations. Therefore, glass compositions of some embodiments do not comprise these alkalis.

When the total content of alkali metal oxides is too high, the liquidus viscosity may decrease. Also, at high content of Alk₂O, low-temperature viscosity of glass may be decreased, which may cause the loss of ion exchange stress due to the stress relaxation. Accordingly, the content of alkali metal oxides is preferably limited.

“Alk₂O” as used herein refers to the total sum of alkali metal oxides in a glass composition, in mol %, specifically Li₂O+Na₂O+K₂O+Rb₂O+Cs₂O. In some embodiments, the glass composition may contain alkali metal oxides Alk₂O in an amount greater than or equal to 9.0 mol. %, or greater than or equal to 14.0 mol. %. In some other embodiments, the glass composition may contain alkali metal oxides Alk₂O in an amount less than or equal to 17.5 mol. %, less than or equal to 16.0 mol. %, less than or equal to 15.5 mol. %, or less than or equal to 14.0 mol. %. In some more embodiments, the glass composition may contain Alk₂O in an amount greater than or equal to 9.0 mol. % and less than or equal to 17.5 mol. %, greater than or equal to 9.0 mol. % and less than or equal to 16.0 mol. %, greater than or equal to 9.0 mol. % and less than or equal to 15.5 mol. %, or greater than or equal to 9.0 mol. % and less than or equal to 14.0 mol. %, greater than or equal to 14.0 mol. % and less than or equal to 17.5 mol. %, greater than or equal to 14.0 mol. % and less than or equal to 16.0 mol. %, or greater than or equal to 14.0 mol. % and less than or equal to 15.5 mol. %.

Glass composition may include sodium oxide (Na₂O). Glass compositions can comprise sodium oxide (Na₂O). The amount of Na₂O in the glass compositions also relates to the ion exchangeability of the glass made from the glass compositions. Specifically, the presence of Na₂O in the glass compositions may increase the ion exchange rate during ion exchange strengthening of the glass by increasing the diffusivity of Na+ ions through the glass matrix. Also, Na₂O may suppress the crystallization of alumina containing species, such as spodumene, mullite and corundum and, therefore, decrease the liquidus temperature and increase the liquidus viscosity. However, without being bound to theory, as the amount of Na₂O present in the glass compositions increases, the compressive stress obtainable in the glass through ion exchange decreases. For example, ion exchange of a sodium ion with another sodium ion of the same size results in no net increase in the compressive stress in the compressive layer, but extra Na₂O softens the glass and speeds up stress relaxation. Thus, increasing the Na₂O amount in the glass compositions often decreases the compressive stress created in the glass by the ion exchange. Also, Na₂O may worsen the mechanical properties of glass since it decreases the elastic modulus and the fracture toughness, and/or decrease the annealing and strain points of glass. Accordingly, it is desirable in embodiments to limit the amount of Na₂O present in the glass compositions. In embodiments, the glass composition may contain sodium oxide (Na₂O) in an amount from greater than or equal to 0.0 mol. % to less than or equal to 15.0 mol. % and all ranges and sub-ranges between the foregoing values. In some embodiments, the glass composition may contain Na₂O in an amount greater than or equal to 0.0 mol. %, greater than or equal to 0.3 mol. %, greater than or equal to 2.0 mol. %, greater than or equal to 2.5 mol. %, greater than or equal to 3.0 mol. %, greater than or equal to 5.0 mol. %, greater than or equal to 6.0 mol. %, greater than or equal to 9.0 mol. %, greater than or equal to 10.0 mol. %, greater than or equal to 11.0 mol. %, or greater than or equal to 13.0 mol. %. In some other embodiments, the glass composition may contain Na₂O in an amount less than or equal to 15.0 mol. %, less than or equal to 13.0 mol. %, less than or equal to 12.5 mol. %, less than or equal to 11.5 mol. %, less than or equal to 11.0 mol. %, less than or equal to 10.5 mol. %, less than or equal to 10.0 mol. %, less than or equal to 9.0 mol. %, less than or equal to 8.0 mol. %, or less than or equal to 5.0 mol. %. In some more embodiments, the glass composition may contain Na₂O in an amount greater than or equal to 0.0 mol. % and less than or equal to 15.0 mol. %, greater than or equal to 0.3 mol. % and less than or equal to 15.0 mol. %, greater than or equal to 2.0 mol. % and less than or equal to 11.5 mol. %, greater than or equal to 2.5 mol. % and less than or equal to 12.5 mol. %, greater than or equal to 3.0 mol. % and less than or equal to 10.5 mol. %, greater than or equal to 3.0 mol. % and less than or equal to 10.0 mol. %, greater than or equal to 5.95 mol. % and less than or equal to 8.33 mol. %, greater than or equal to 0.0 mol. % and less than or equal to 5.0 mol. %, greater than or equal to 2.0 mol. % and less than or equal to 5.0 mol. %, greater than or equal to 3.0 mol. % and less than or equal to 5.0 mol. %, greater than or equal to 5.0 mol. % and less than or equal to 15.0 mol. %, greater than or equal to 6.0 mol. % and less than or equal to 8.0 mol. %.

Glass composition may include lithium oxide (Li₂O). In embodiments, the glass composition comprises lithium oxide, Li₂O. Without being bound by theory, adding this component to a glass composition makes a glass suitable to high-performance ion exchange of lithium ion (Li⁺) for a larger alkali metal ion, such as sodium ion (Na⁺), for example, in order to make a compressed ion-exchanged layer near to the glass surface that increases the strength of a glass article to bending and tension. In embodiments, the glass composition may contain lithium oxide (Li₂O) in an amount from greater than or equal to 0.3 mol. % to less than or equal to 11.0 mol. % and all ranges and sub-ranges between the foregoing values. In some embodiments, the glass composition may contain Li₂O in an amount greater than or equal to 0.3 mol. %, greater than or equal to 0.5 mol. %, greater than or equal to 1.0 mol. %, greater than or equal to 2.0 mol. %, greater than or equal to 2.5 mol. %, greater than or equal to 3.0 mol. %, greater than or equal to 3.2 mol. %, greater than or equal to 5.0 mol. %, greater than or equal to 5.6 mol. %, greater than or equal to 7.05 mol. %, greater than or equal to 8.0 mol. %, greater than or equal to 9.0 mol. %, or greater than or equal to 10.0 mol. %. In some other embodiments, the glass composition may contain Li₂O in an amount less than or equal to 11.0 mol. %, less than or equal to 10.0 mol. %, less than or equal to 9.0 mol. %, less than or equal to 7.95 mol. %, less than or equal to 7.75 mol. %, less than or equal to 7.5 mol. %, less than or equal to 7.2 mol. %, less than or equal to 6.6 mol. %, less than or equal to 5.0 mol. %, or less than or equal to 1.0 mol. %. In some more embodiments, the glass composition may contain Li₂O in an amount greater than or equal to 0.3 mol. % and less than or equal to 7.5 mol. %, greater than or equal to 0.5 mol. % and less than or equal to 10.0 mol. %, greater than or equal to 2.0 mol. % and less than or equal to 8.0 mol. %, greater than or equal to 2.5 mol. % and less than or equal to 7.5 mol. %, greater than or equal to 3.0 mol. % and less than or equal to 7.95 mol. %, greater than or equal to 3.2 mol. % and less than or equal to 7.2 mol. %, greater than or equal to 5.56 mol. % and less than or equal to 6.64 mol. %, greater than or equal to 7.05 mol. % and less than or equal to 7.75 mol. %, greater than or equal to 0.3 mol. % and less than or equal to 11.0 mol. %, greater than or equal to 0.3 mol. % and less than or equal to 1.0 mol. %, greater than or equal to 0.5 mol. % and less than or equal to 1.0 mol. %, greater than or equal to 1.0 mol. % and less than or equal to 11.0 mol. %, greater than or equal to 2.0 mol. % and less than or equal to 11.0 mol. %, greater than or equal to 2.0 mol. % and less than or equal to 5.0 mol. %, greater than or equal to 2.5 mol. % and less than or equal to 11.0 mol. %, greater than or equal to 3.0 mol. % and less than or equal to 5.0 mol. %.

Glass composition may include potassium oxide (K₂O). The glass compositions, according to embodiments may further include K₂O. The amount of K₂O present in the glass compositions also relates to the ion exchangeability of the glass composition. Specifically, as the amount of K₂O present in the glass composition increases, the compressive stress in the glass obtainable through ion exchange decreases as a result of the exchange of potassium and sodium ions. Also, the potassium oxide, like the sodium oxide, may decrease the liquidus temperature and increase the liquidus viscosity, but at the same time decrease the elastic modulus and fracture toughness and/or decrease the annealing and strain points. Accordingly, it is desirable to limit the amount of K₂O present in the glass compositions. In embodiments, the glass composition may contain potassium oxide (K₂O) in an amount from greater than or equal to 0.0 mol. % to less than or equal to 0.5 mol. % and all ranges and sub-ranges between the foregoing values. In some other embodiments, the glass composition may contain K₂O in an amount less than or equal to 0.5 mol. % or less than or equal to 0.25 mol. %. In some more embodiments, the glass composition may contain K₂O in an amount greater than or equal to 0.0 mol. % and less than or equal to 0.5 mol. %, greater than or equal to 0.0 mol. % and less than or equal to 0.25 mol. %.

Glass composition may have limitations for the amount of rare earth metal oxides. Rare earth metal oxides may be added to the glass composition to provide a number of physical and chemical attributes to the resulting glass article. Rare earth metal oxides refer to the oxides of metals listed in the Lanthanide Series of the IUPAC Periodic Table plus yttrium and scandium. The presence of rare earth metal oxides in the glass composition may increase the modulus, stiffness, or modulus and stiffness of the resultant glass. Rare earth metal oxides may also help to increase the liquidus viscosity of the glass composition. Additionally, certain rare earth metal oxides may add color to the glass. If no color is required or desired, then the glass composition may include lanthanum oxide (La₂O₃), yttrium oxide (Y₂O₃), gadolinium oxide (Gd₂O₃), ytterbium oxide (Yb₂O₃), lutetium oxide (Lu₂O₃), or combinations of these. For colored glasses, the rare earth metal oxides may include Ce₂O₃, Pr₂O₃, Nd₂O₃, Sm₂O₃, Eu₂O₃, Tb₂O₃, Dy₂O₃, HO₂O₃, Er₂O₃, Tm₂O₃, or combinations of these. Some rare earth metal oxides such as Ce₂O₃ and Gd₂O₃ absorb UV radiation and thus cover glasses containing these oxides can protect OLED display devices from deleterious UV radiation.

Rare earth metal oxides can be added in small concentrations to the glass compositions of the present disclosure for higher elastic moduli, higher fracture toughness and higher low-temperature viscosity, at the same time reducing the high-temperature viscosity of the glass forming melts, which can save energy when melting. However, at high concentrations of REₘOₙ, the liquidus viscosity of glass can be decreased. Also, rare earth metal oxides are comparably expensive, and they may slow down the process of ion exchange. Accordingly, the content of rare earth metal oxides is preferably limited, or glass compositions may be substantially free of REₘOₙ.

“REₘOₙ” as used herein refers to the total sum of rare earth metal oxides in a glass composition, in mol %, specifically La₂O₃+Y₂O₃+Gd₂O₃+Yb₂O₃+Lu₂O₃+Ce₂O₃+Pr₂O₃+Nd₂O₃+Sm₂O₃+Eu₂O₃+Tb₂O₃+Dy₂O₃+H₂O₃+Er₂O₃+Tm₂O₃. In some embodiments, the glass composition may contain rare earth metal oxides REₘOₙ in an amount less than or equal to 1.5 mol. %, less than or equal to 1.0 mol. %, or less than or equal to 0.3 mol. %. In some more embodiments, the glass composition may contain REₘOₙ in an amount greater than or equal to 0.0 mol. % and less than or equal to 1.5 mol. %, greater than or equal to 0.0 mol. % and less than or equal to 0.3 mol. %, greater than or equal to 0.0 mol. % and less than or equal to 1.0 mol. %.

Glass composition may include titania (TiO₂). Titania can be added to the glass composition of the present disclosure to increase the elastic moduli and fracture toughness of glass without significant increase of the density. However, titania may slow down the process of the ion exchange. Also, titania may provide undesirable coloring to the glass. Accordingly, the content of titania is preferably limited, or glass compositions may be substantially free of TiO₂. In embodiments, the glass composition may contain titania (TiO₂) in an amount from greater than or equal to 0.0 mol. % to less than or equal to 5.0 mol. % and all ranges and sub-ranges between the foregoing values. In some other embodiments, the glass composition may contain TiO₂ in an amount less than or equal to 5.0 mol. %, less than or equal to 2.5 mol. %, less than or equal to 1.0 mol. %, less than or equal to 0.475 mol. %, or less than or equal to 0.42 mol. %. In some more embodiments, the glass composition may contain TiO₂ in an amount greater than or equal to 0.0 mol. % and less than or equal to 1.0 mol. %, greater than or equal to 0.0 mol. % and less than or equal to 0.475 mol. %, greater than or equal to 0.0 mol. % and less than or equal to 0.42 mol. %, greater than or equal to 0.0 mol. % and less than or equal to 5.0 mol. %.

Glass composition may include zirconia (ZrO₂). Zirconia can be added in a small concentrations to the glass compositions of the present disclosure to increase the elastic moduli, fracture toughness and low-temperature viscosity. However, it was empirically found that in the aluminosilicate glasses with high content of alumina, addition of even very small amount of ZrO₂, such as 1 mol. % or even less, may increase the liquidus temperature and, therefore, adversely cause crystallization of the refractory minerals, such as zirconia (ZrO₂), zircon (ZrSiO₄) and others, from the glass forming melt at high temperatures. Accordingly, the content of zirconia is preferably limited, or glass compositions may be substantially free of ZrO₂. In embodiments, the glass composition may contain zirconia (ZrO₂) in an amount from greater than or equal to 0.0 mol. % to less than or equal to 5.0 mol. % and all ranges and sub-ranges between the foregoing values. In some other embodiments, the glass composition may contain ZrO₂ in an amount less than or equal to 5.0 mol. %, less than or equal to 2.5 mol. %, or less than or equal to 1.0 mol. %. In some more embodiments, the glass composition may contain ZrO₂ in an amount greater than or equal to 0.0 mol. % and less than or equal to 1.0 mol. %, greater than or equal to 0.0 mol. % and less than or equal to 5.0 mol. %.

Glass composition may include tin oxide (SnO₂). Tin oxide can be added to the glass compositions of the present disclosure in small concentrations as a fining agent. However, it was empirically found that in some cases, and especially when the content of Al₂O₃ is greater than or equal to the total content of modifiers and P₂O₅ (R₂O+RO+P₂O₅), addition of even very small amounts of SnO₂, sometimes less than 0.25 mol. %, or even less than 0.1 mol. %, may cause precipitation of cassiterite (SnO₂) from the melt at high temperatures Accordingly, the content of tin oxide is preferably limited, or glass compositions may be substantially free of SnO₂. In embodiments, the glass composition may contain tin oxide (SnO₂) in an amount from greater than or equal to 0.0 mol. % to less than or equal to 5.0 mol. % and all ranges and sub-ranges between the foregoing values. In some other embodiments, the glass composition may contain SnO₂ in an amount less than or equal to 5.0 mol. %, less than or equal to 2.5 mol. %, or less than or equal to 0.5 mol. %. In some more embodiments, the glass composition may contain SnO₂ in an amount greater than or equal to 0.0 mol. % and less than or equal to 0.5 mol. %, greater than or equal to 0.0 mol. % and less than or equal to 5.0 mol. %.

Glass composition may include barium oxide (BaO). Barium oxide (and, in less extent, strontium oxide) can be added to the glass compositions of the present disclosure to reduce the high-temperature viscosity and improve the meltability. However, addition of BaO, even in small concentrations, such as 1 mol. % or even less, may significantly decrease the elastic moduli and fracture toughness of glass. Then, BaO increases the density of glass. Also, it was empirically found that sometimes addition of BaO may increase the liquidus temperature. Accordingly, the content of barium oxide is preferably limited, or glass compositions may be substantially free of BaO. In embodiments, the glass composition may contain barium oxide (BaO) in an amount from greater than or equal to 0.0 mol. % to less than or equal to 5.0 mol. % and all ranges and sub-ranges between the foregoing values. In some other embodiments, the glass composition may contain BaO in an amount less than or equal to 5.0 mol. %, less than or equal to 2.5 mol. %, or less than or equal to 0.5 mol. %. In some more embodiments, the glass composition may contain BaO in an amount greater than or equal to 0.0 mol. % and less than or equal to 0.5 mol. %, greater than or equal to 0.0 mol. % and less than or equal to 5.0 mol. %.

Glass composition may include calcium oxide (CaO). Without being bound to theory, the presence of CaO may increase the liquidus viscosity of the glass compositions. However, too much CaO in a glass composition may decrease the rate of ion exchange in the resultant glass. Accordingly, the content of calcium oxide is preferably limited, or glass compositions may be substantially free of CaO. In embodiments, the glass composition may contain calcium oxide (CaO) in an amount from greater than or equal to 0.0 mol. % to less than or equal to 5.0 mol. % and all ranges and sub-ranges between the foregoing values. In some other embodiments, the glass composition may contain CaO in an amount less than or equal to 5.0 mol. %, less than or equal to 2.5 mol. %, less than or equal to 1.0 mol. %, less than or equal to 0.95 mol. %, less than or equal to 0.85 mol. %, or less than or equal to 0.23 mol. %. In some more embodiments, the glass composition may contain CaO in an amount greater than or equal to 0.0 mol. % and less than or equal to 2.5 mol. %, greater than or equal to 0.0 mol. % and less than or equal to 1.0 mol. %, greater than or equal to 0.0 mol. % and less than or equal to 0.95 mol. %, greater than or equal to 0.0 mol. % and less than or equal to 0.85 mol. %, greater than or equal to 0.04 mol. % and less than or equal to 0.23 mol. %, greater than or equal to 0.0 mol. % and less than or equal to 5.0 mol. %, greater than or equal to 0.0 mol. % and less than or equal to 0.23 mol. %.

Glass composition may include zinc oxide (ZnO). Glass compositions, according to embodiments, may contain a small amount of zinc oxide, ZnO. Zinc oxide may partially compensate the excess of Al₂O₃, which leads to some suppression of crystallization of mullite and, therefore, reduces the liquidus temperature and increases the liquidus viscosity. Also, zinc, contrary to magnesium and other species, does not form refractory aluminosilicates. However, at an excess of Al₂O₃, zinc oxide, solely or together with the magnesium oxide, may form spinel that may crystallize at high temperatures and, therefore, in this case ZnO may increase the liquidus temperature and reduce the liquidus viscosity. Accordingly, the content of zinc oxide is preferably limited, or glass compositions may be substantially free of ZnO. In embodiments, the glass composition may contain zinc oxide (ZnO) in an amount from greater than or equal to 0.0 mol. % to less than or equal to 4.0 mol. % and all ranges and sub-ranges between the foregoing values. In some other embodiments, the glass composition may contain ZnO in an amount less than or equal to 4.0 mol. %, less than or equal to 2.0 mol. %, less than or equal to 1.0 mol. %, less than or equal to 0.9 mol. %, less than or equal to 0.825 mol. %, less than or equal to 0.75 mol. %, or less than or equal to 0.6 mol. %. In some more embodiments, the glass composition may contain ZnO in an amount greater than or equal to 0.0 mol. % and less than or equal to 4.0 mol. %, greater than or equal to 0.0 mol. % and less than or equal to 1.0 mol. %, greater than or equal to 0.0 mol. % and less than or equal to 0.75 mol. %, greater than or equal to 0.1 mol. % and less than or equal to 0.9 mol. %, greater than or equal to 0.2 mol. % and less than or equal to 1.0 mol. %, greater than or equal to 0.2 mol. % and less than or equal to 0.825 mol. %, greater than or equal to 0.32 mol. % and less than or equal to 0.62 mol. %, greater than or equal to 0.0 mol. % and less than or equal to 0.6 mol. %.

Glass composition may include magnesia (MgO). In the embodiments of the present disclosure, it was empirically found that magnesia provides greater increasing the elastic moduli than other divalent metal oxides, except for BeO, not providing adverse increase to the density. However, when MgO is added in a high concentration, it can increase the liquidus temperature and cause precipitation of refractory minerals, such as spinel (MgAl₂O₄), forsterite (Mg₂SiO₄) and others, from the glass forming melts at high temperatures. Also, at high concentrations, MgO can slow down the ion exchange and reduce chemical durability of glasses. Accordingly, the content of magnesia is preferably limited, or glass compositions may be substantially free of MgO. In embodiments, the glass composition may contain magnesia (MgO) in an amount from greater than or equal to 0.0 mol. % to less than or equal to 4.8 mol. % and all ranges and sub-ranges between the foregoing values. In some other embodiments, the glass composition may contain MgO in an amount less than or equal to 4.8 mol. %, less than or equal to 4.0 mol. %, less than or equal to 3.5 mol. %, less than or equal to 3.1 mol. %, less than or equal to 2.9 mol. %, less than or equal to 2.85 mol. %, or less than or equal to 2.5 mol. %. In some more embodiments, the glass composition may contain MgO in an amount greater than or equal to 0.0 mol. % and less than or equal to 4.8 mol. %, greater than or equal to 1.0 mol. % and less than or equal to 4.0 mol. %, greater than or equal to 1.0 mol. % and less than or equal to 3.5 mol. %, greater than or equal to 1.2 mol. % and less than or equal to 3.1 mol. %, greater than or equal to 1.45 mol. % and less than or equal to 2.85 mol. %, greater than or equal to 1.66 mol. % and less than or equal to 2.87 mol. %, greater than or equal to 0.0 mol. % and less than or equal to 2.5 mol. %. Preferably, the glass composition contains MgO in an amount equal to or greater than 1.2 mol %.

Glass composition may include alumina (Al₂O₃). The glass compositions according to embodiments, include alumina (Al₂O₃). Al₂O₃, in conjunction with alkali metal oxides present in the glass compositions such as Li₂O, or the like, improves the susceptibility of the glass to ion exchange strengthening. More specifically, increasing the amount of Al₂O₃ in the glass compositions increases the speed of ion exchange in the glass and increases the compressive stress produced in the compressive layer of the glass as a result of ion exchange. Without being bound to theory, alkali metal oxides compensated with Al₂O₃ exhibit greater mobility during ion exchange compared to alkali oxides that are not compensated with Al₂O₃. The Al₂O₃ may also increase the hardness and damage resistance of the glass, especially if its content in glass (in mole percent) exceeds the total content of alkali metal oxides (also in mole percent). Also, the Al₂O₃ may increase the annealing and strain points of a glass, which make the glass more durable to high temperatures. However, addition of Al₂O₃ to a glass composition usually increases the liquidus temperature due to formation of various refractory species, such as, for example, spodumene, corundum, mullite, etc. This may lead to decreasing the liquidus viscosity and, therefore, may cause the glass composition to crystallize during production, for example, during a fusion downdraw process. Accordingly, glass compositions of embodiments comprise Al₂O₃ in an amount that exceeds the total content of alkali metal oxides, but does not decrease the liquidus viscosity too much. In embodiments, the glass composition may contain alumina (Al₂O₃) in an amount from greater than or equal to 1.0 mol. % to less than or equal to 20.0 mol. % and all ranges and sub-ranges between the foregoing values. In some embodiments, the glass composition may contain Al₂O₃ in an amount greater than or equal to 1.0 mol. %, greater than or equal to 5.0 mol. %, greater than or equal to 10.0 mol. %, greater than or equal to 11.0 mol. %, greater than or equal to 11.5 mol. %, greater than or equal to 12.0 mol. %, greater than or equal to 12.2 mol. %, greater than or equal to 13.6 mol. %, greater than or equal to 14.0 mol. %, greater than or equal to 16.0 mol. %, or greater than or equal to 18.0 mol. %. In some other embodiments, the glass composition may contain Al₂O₃ in an amount less than or equal to 20.0 mol. %, less than or equal to 18.0 mol. %, less than or equal to 17.5 mol. %, less than or equal to 16.5 mol. %, less than or equal to 16.0 mol. %, less than or equal to 15.8 mol. %, less than or equal to 15.0 mol. %, less than or equal to 14.7 mol. %, less than or equal to 14.0 mol. %, less than or equal to 10.0 mol. %, or less than or equal to 5.0 mol. %. In some more embodiments, the glass composition may contain Al₂O₃ in an amount greater than or equal to 1.0 mol. % and less than or equal to 20.0 mol. %, greater than or equal to 5.0 mol. % and less than or equal to 20.0 mol. %, greater than or equal to 10.0 mol. % and less than or equal to 17.5 mol. %, greater than or equal to 11.0 mol. % and less than or equal to 15.0 mol. %, greater than or equal to 11.5 mol. % and less than or equal to 16.5 mol. %, greater than or equal to 12.0 mol. % and less than or equal to 18.0 mol. %, greater than or equal to 12.2 mol. % and less than or equal to 15.8 mol. %, greater than or equal to 13.56 mol. % and less than or equal to 14.7 mol. %, greater than or equal to 1.0 mol. % and less than or equal to 5.0 mol. %, greater than or equal to 10.0 mol. % and less than or equal to 14.0 mol. %, greater than or equal to 11.0 mol. % and less than or equal to 20.0 mol. %, greater than or equal to 11.0 mol. % and less than or equal to 14.0 mol. %, greater than or equal to 11.5 mol. % and less than or equal to 20.0 mol. %, greater than or equal to 11.5 mol. % and less than or equal to 14.0 mol. %, greater than or equal to 12.2 mol. % and less than or equal to 14.0 mol. %.

In some other embodiments, the glass composition may have a sum of La₂O₃+Y₂O₃ less than or equal to 0.2 mol. % or less than or equal to 0.1 mol. %. In some more embodiments, the glass composition may have a La₂O₃+Y₂O₃ greater than or equal to 0.0 mol. % and less than or equal to 0.2 mol. %, or greater than or equal to 0.0 mol. % and less than or equal to 0.1 mol. %.

In some embodiments, the glass composition may have a sum of Li₂O+Na₂O greater than or equal to 0.0 mol. %, greater than or equal to 10.0 mol. %, or greater than or equal to 12.0 mol. %. In some other embodiments, the glass composition may have a sum of Li₂O+Na₂O less than or equal to 17.5 mol. %, less than or equal to 15.0 mol. %, or less than or equal to 10.0 mol. %. In some more embodiments, the glass composition may have a Li₂O +Na₂O greater than or equal to 12.0 mol. % and less than or equal to 17.5 mol. %, greater than or equal to 0.0 mol. % and less than or equal to 17.5 mol. %, greater than or equal to 0.0 mol. % and less than or equal to 15.0 mol. %, or greater than or equal to 0.0 mol. % and less than or equal to 10.0 mol. %, greater than or equal to 10.0 mol. % and less than or equal to 17.5 mol. %, or greater than or equal to 10.0 mol. % and less than or equal to 15.0 mol. %, or greater than or equal to 12.0 mol. % and less than or equal to 15.0 mol. %.

“RO” as used herein refers to the total sum of MgO+CaO+SrO+BaO+ZnO. In some embodiments, the glass composition may have a sum of MgO+CaO+SrO+BaO+ZnO greater than or equal to 0.0 mol. %, or greater than or equal to 5.0 mol. %. In some other embodiments, the glass composition may have a sum of MgO+CaO+SrO+BaO+ZnO less than or equal to 10.0 mol. % or less than or equal to 5.0 mol. %. In some more embodiments, the glass composition may have a MgO+CaO+SrO+BaO+ZnO greater than or equal to 0.0 mol. % and less than or equal to 10.0 mol. %, or greater than or equal to 0.0 mol. % and less than or equal to 5.0 mol. %.

In some embodiments, the glass composition may have a sum of SiO₂+Al₂O₃+B₂O₃+P₂O₅+Li₂O+Na₂O+MgO greater than or equal to 98.0 mol. %.

In some embodiments, glass composition may have limitations for a ratio (MgO+CaO+ZnO)/RO. Magnesia, calcium oxide and zinc oxide can be preferably used in some embodiments of the present disclosure to increase the elastic moduli and fracture toughness. Accordingly, in some embodiments of the present disclosure, the glass compositions are characterized by a high ratio of (MgO+CaO+ZnO) to the total content of divalent metal oxides (RO). In some embodiments, the glass may have a ratio (MgO+CaO+ZnO)/RO [mol. %] greater than or equal to 0.000, or greater than or equal to 0.8.

In some embodiments, glass composition may have limitations for a ratio Li₂O/Alk₂O. Lithium oxide provides faster ion exchange and deeper exchanged layer than other alkalis. Accordingly, in some embodiments of the present disclosure it is preferable when the content of Li₂O is greater than the total content of other alkali metal oxides. However, when a glass composition contains no or very little amount of other alkalis, such as, for example, Na₂O and K₂O, it may become difficult to reach high liquidus viscosity. Also, some addition of other alkalis, primarily Na₂O, can speed up the ion exchange due to better diffusivity of sodium ionsin a glass. Accordingly, in some embodiments of the present disclosure, the ratio Li₂O/Alk₂O is limited. In some embodiments, the glass may have a ratio Li₂O/Alk₂O greater than or equal to 0.420 mol. %, or greater than or equal to 0.500 mol. %. In some other embodiments, the glass may have a ratio Li₂O/Alk₂O less than or equal to 0.550 mol. %, less than or equal to 0.520 mol. %, or less than or equal to 0.500 mol. %. In some more embodiments, the glass may have a Li₂O/Alk₂O greater than or equal to 0.500 mol. % and less than or equal to 0.550 mol. %, greater than or equal to 0.420 mol. % and less than or equal to 0.550 mol. %, greater than or equal to 0.420 mol. % and less than or equal to 0.520 mol. %, or greater than or equal to 0.420 mol. % and less than or equal to 0.500 mol. %, or greater than or equal to 0.500 mol. % and less than or equal to 0.520 mol. %.

In some embodiments, glass composition may have limitations for a ratio Alk₂O/Al₂O₃. When the ratio Alk₂O/Al₂O₃ is too low, it may become difficult to reach high ion exchange stress because of insufficient content of alkalis. When the ratio Alk₂O/Al₂O₃ is too high, the stress generated during ion exchange can be lost due to the stress relaxation, because in this case the low-temperature viscosity of glass may be decreased and the stress relaxation time decreased respectively. The preferable values of the ratio Alk₂O/Al₂O₃ are close to 1.0, which may provide a better balance between the content of alkali metal oxides in the glass compositions and the stress relaxation time. In some embodiments, the glass may have a ratio Alk₂O/Al₂O₃ greater than or equal to 0.85 mol. %, greater than or equal to 0.89 mol. %, greater than or equal to 0.90 mol. %, or greater than or equal to 1.05 mol. %. In some other embodiments, the glass may have a ratio Alk₂O/Al₂O₃ less than or equal to 1.20 mol. %, less than or equal to 1.10 mol. %, less than or equal to 1.09 mol. %, less than or equal to 1.06 mol. %, less than or equal to 1.05 mol. %, less than or equal to 1.00 mol. %, or less than or equal to 0.96 mol. %. In some more embodiments, the glass may have a Alk₂O/Al₂O₃ greater than or equal to 0.85 mol. % and less than or equal to 1.20 mol. %, greater than or equal to 0.85 mol. % and less than or equal to 1.09 mol. %, greater than or equal to 0.85 mol. % and less than or equal to 1.00 mol. %, greater than or equal to 0.85 mol. % and less than or equal to 0.96 mol. %, greater than or equal to 0.90 mol. % and less than or equal to 1.10 mol. %, greater than or equal to 0.85 mol. % and less than or equal to 1.05 mol. %, greater than or equal to 0.89 mol. % and less than or equal to 1.20 mol. %, greater than or equal to 0.89 mol. % and less than or equal to 1.09 mol. %, greater than or equal to 0.89 mol. % and less than or equal to 1.05 mol. %, or greater than or equal to 0.89 mol. % and less than or equal to 0.96 mol. %, greater than or equal to 0.90 mol. % and less than or equal to 1.20 mol. %, greater than or equal to 0.90 mol. % and less than or equal to 1.09 mol. %, greater than or equal to 0.90 mol. % and less than or equal to 1.05 mol. %, or greater than or equal to 0.90 mol. % and less than or equal to 0.96 mol. %.

In some embodiments, the glass may have the Young's modulus E greater than or equal to 70 GPa.

In some embodiments, the glass may have the decimal logarithm of liquidus viscosity Log(η_{liq}, P) [P] greater than or equal to 5. In some embodiments, the glass may have the Log(η_{liq}, P) [P] greater than or equal to 5, or greater than or equal to 5.3.

In some embodiments, the glass may have a RO balance parameter P_{RO} greater than or equal to −2, or greater than or equal to 0.000. In some other embodiments, the glass may have a RO balance parameter P_{RO} less than or equal to 2 or less than or equal to 0.000. In some more embodiments, the glass may have a P_{RO} greater than or equal to −2 and less than or equal to 2, or greater than or equal to −2 and less than or equal to 0.000.

In some other embodiments, the glass may have a quantity Pₒₓ−(1.5+P_{RO}) less than or equal to 0.000.

In some other embodiments, the glass may have a quantity Pₒₓ−(0.5+P_{RO}) less than or equal to 0.000.

Oxygen balance parameter Pₒₓ is a quantity calculated by the following formula (I):

Pₒₓ=(Alk₂O+RO)−(Al₂O₃+P₂O₅), (I)

where Alk₂O is total sum of alkali metal oxides, RO is total sum of divalent metal oxides, and chemical formulas mean the amounts of corresponding components in the glass composition.

The value of Pₒₓ evaluates the balance between network formers (Al₂O₃ and P₂O₅) and modifiers (R₂O and RO) in the glass composition. Not being bounded to any specific theory, the inventors believe that when the total amount of Al₂O₃ and P₂O₅ in the glass composition, in terms of mol. %, is greater than or equal to the total amount of R₂O and RO, in terms of mol. %, all cations of said modifiers are connected to one of [AlO₄] or [PO₄] tetrahedra, which may increase the diffusivity of alkali metal ions and, therefore, reduce the time of ion exchange and better preserve the glass from loss of stress due to stress relaxation.

When the difference between the value of Pₒₓ reaches big negative values, this may cause increasing the liquidus temperature and/or reducing the high-temperature viscosity, which may further decrease the liquidus viscosity, thus making the process of glass forming more complicated, or may cause precipitation of refractory minerals (such as, for example, corundum Al₂O₃, mullite Al₆Si₂O₁₃, aluminum phosphate AlPO₄, and others) from the glass forming melt when forming or cooling. Therefore, it is desirable to avoid big negative values of Pₒₓ.

In turn, when the Pₒₓ reach big positive values, this may mean that some alkali cations may be connected to non-bridging oxygen atoms. Not being bounded to a specific theory, the inventors believe that in this case the diffusivity of alkali metal ions may be decreased, which may increase the time required for ion exchange and, therefore, cause the loss of stress due to stress relaxation.

Accordingly, in some embodiments of the present disclosure it is preferable that Pₒₓ has zero, small positive or small negative values.

RO balance parameter P_{RO} is a quantity calculated by the following formula (II):

P_{RO}=(MgO+CaO+ZnO)−(B₂O₃+P₂O₅), (II)

where chemical formulas mean the amounts of corresponding components in the glass composition.

It was empirically found that addition of MgO, CaO and ZnO in the glass compositions of the present disclosure may sometimes cause such undesirable effects as crystallization of the glass forming melt when cooling or forming the glass articles and reducing the diffusivity of alkali metal ions during ion exchange; however, these effects may be reduced when the total sum of (MgO+CaO+ZnO), in mol. %, is in approximate balance with total sum of B₂O₃ and P₂O₅, in terms of mol. %. In turn, when the total sum of (B₂O₃+P₂O₅) exceeds the total sum of (MgO+CaO+ZnO), this may lead to decreasing the liquidus viscosity. Accordingly, in some embodiments of the present disclosure it is preferable when the difference between (MgO+CaO+ZnO) and (B₂O₃+P₂O₅), in mol. %, has zero, small positive or small negative values.

Table 1 identifies the combination of components and their respective amounts according to some embodiments of the present disclosure. The Exemplary Glasses A in Table 1 may include additional components according to any aspects of the present disclosure as described herein.

TABLE 1
Exemplary Glasses A

| Component | Amount (mol. %) | |
|---|---|---|
| SiO₂ | 60.0 to 70.0 | mol. % |
| Al₂O₃ | 5.0 to 20.0 | mol. % |
| MgO | 1.0 to 4.0 | mol. % |
| Li₂O | 0.5 to 10.0 | mol. % |
| P₂O₅ | 0.5 to 6.0 | mol. % |
| Na₂O | 0.0 to 15.0 | mol. % |
| B₂O₃ | 0.0 to 5.0 | mol. % |
| Total sum of alkali | ≤16.0 | mol. % |

metal oxides Alk₂O

Exemplary Glasses A according to embodiments of the present disclosure may satisfy the following condition:

0.85≤Alk₂O/Al₂O₃ [mol. %]≤1.2,

where chemical formulas refer to the amounts of components in glass, expressed in mol. %.

Table 2 identifies the combination of components and their respective amounts according to some embodiments of the present disclosure. The Exemplary Glasses B in Table 2 may include additional components according to any aspects of the present disclosure as described herein.

TABLE 2
Exemplary Glasses B

| Component | Amount (mol. %) | |
|---|---|---|
| SiO₂ | 58.0 to 69.9 | mol. % |
| Na₂O | 3.0 to 10.0 | mol. % |
| Li₂O | 3.0 to 8.0 | mol. % |
| Al₂O₃ | 1.0 to 20.0 | mol. % |
| Sum of (Li₂O + Na₂O) | 12.0 to 17.5 | mol. % |
| Total sum of alkali | 9.0 to 17.5 | mol. % |

metal oxides Alk₂O

Exemplary Glasses B according to embodiments of the present disclosure may satisfy the following condition:

0.50≤Li₂O/Alk₂O [mol. %]≤0.55,

where chemical formulas refer to the amounts of components in glass, expressed in mol. %.

According to some embodiments of the present disclosure, Exemplary Glasses B may also satisfy the following condition:

0.85≤Alk₂O/Al₂O₃ [mol. %]≤1,

where chemical formulas refer to the amounts of components in glass, expressed in mol. %.

According to some embodiments of the present disclosure, Exemplary Glasses B may also have a RO balance parameter P_{RO} from −2 to 2.

According to some embodiments of the present disclosure, Exemplary Glasses B may also satisfy the following formula:

Pₒₓ−(1.5+P_{RO})<0.000,

where Pₒₓ is a oxygen balance parameter, and P_{RO} is a RO balance parameter.

According to some embodiments of the present disclosure, Exemplary Glasses B may also satisfy the following formula:

Pₒₓ−(0.5+P_{RO})<0.000,

where Pₒₓ is a oxygen balance parameter, and P_{RO} is a RO balance parameter.

### EXAMPLES

The following examples describe various features and advantages provided by the disclosure, and are in no way intended to limit the invention and appended claims.

The fracture toughness Klc is a property which describes the ability of a material containing a crack to resist fracture. The linear-elastic fracture toughness of a material is determined from the stress intensity factor KI (usually measured in MPa·m½) at which a thin crack in the material begins to grow. The fracture toughness was measured by the chevron notch method on replicate specimens and averaged according to ASTM C1421-18.

Embodiments of glass articles also have high elastic modulus (i.e., the ratio of the force exerted upon a substance or body to the resultant deformation). High elastic modulus makes a glass article more rigid and allows it to avoid large deformations under an external force that may take place. The most common of stiffness of a material is the Young's modulus E, (i.e., the relationship between stress (force per unit area) and strain (proportional deformation) in an article made of this material). The higher the Young's modulus of material, the less the deformation.

Another characteristic of glass articles according to embodiments combines two factors; Young's modulus and density as the specific modulus E/d (i.e., Young's modulus E divided by the density d).

According to embodiments, the CTE of a glass article may determine the possible changes of the linear size of the substrate caused by temperature changes. The less the CTE, the less temperature-induced deformation. This property is measured by using a horizontal dilatometer (push-rod dilatometer) in accordance with ASTM E228-11.

According to embodiments, the glass composition may be melted at a temperature corresponding to the viscosity of 200 Poises (200P temperature). The relationship between the viscosity and temperature of a glass-forming melt is, essentially, a function of chemical composition of the glass that is melted. The glass viscosity was measured by the rotating crucible method according to ASTM C965-96 (2017).

After the batch materials are melted, it is desirable avoid crystallization when forming a glass sheet, ribbon, or other articles from the said melt. For glass-forming substances, the main numerical characteristic of the crystallization process is the liquidus temperature, TL, that specifies the minimum temperature above which a material is completely liquid, and the maximum temperature at which crystals can co-exist with the melt in thermodynamic equilibrium. This property is measured by the gradient method. This method conforms to ASTM C829-81 Standard Practices for Measurement of Liquidus Temperature of Glass. Accordingly, the glass forming process normally takes place at the temperature higher than TL. On the other hand, the liquidus viscosity of the glass composition can be used to determine which forming processes that can be used to make glass into a sheet is determined by the liquidus viscosity. The greater the liquidus viscosity the more forming processes will be compatible with the glass. Since glass viscosity decreases exponentially with temperature, it is desirable to keep the liquidus temperature as low as possible to maximize the viscosity at the liquidus. For float processing the glass composition generally has a liquidus viscosity of at least 10 kP, and the fusion process requires a liquidus viscosity of at least 50 kP, such as at least 100 kP, or at least 500 kP. For other processes, such as hot pressing, twin-rollers technique, etc. the viscosity value may be considerably lower. For example, for hot pressing that is used on occasion in optical industry, a liquidus viscosity of 10 to 20 poises may be satisfactory.

The chemical durability was measured by immersing the glass samples to 5 mass % water solution of HCl at 95° C. for 24 hours and 5 mass % NaOH at 95° C. for 6 hours. Before making tests, the samples were rinsed under distilled water (16 M resistance) for 5 minutes while squeezing the Tygon tubing to make a shower-like rinse; ultrasonicated (50/60 Hz frequency) in 60° C. to 65° C. 4% Semiclean Detergent bath for one minute; again, rinsed under 16 M distilled water for 5 minutes while squeezing the Tygon tubing to make a shower-like rinse; followed by a final rinse in a cascading 18 M distilled water bath for 5 minutes. The samples were then transferred onto glass racks on stainless steel trays and dried in a 110° C. oven for an hour, and placed in a desiccator until used. HCl tests were done in Pyrex tubes in hot water bath; NaOH was done in platinum tubes, same bath type. After the treatment, the samples were flood-rinsed in 16 and 18 M distilled water, dried in a 110° C. oven for about 30 minutes, and weighed to determine the loss of mass.

Compressive stress (including surface CS) after ion exchange was measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient”.

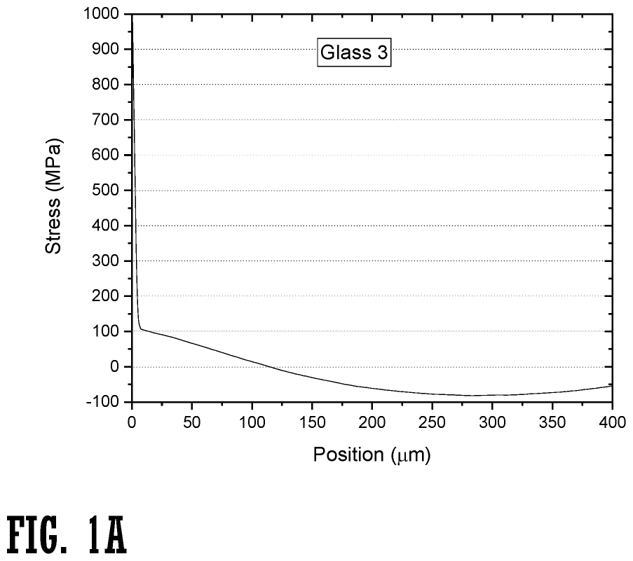

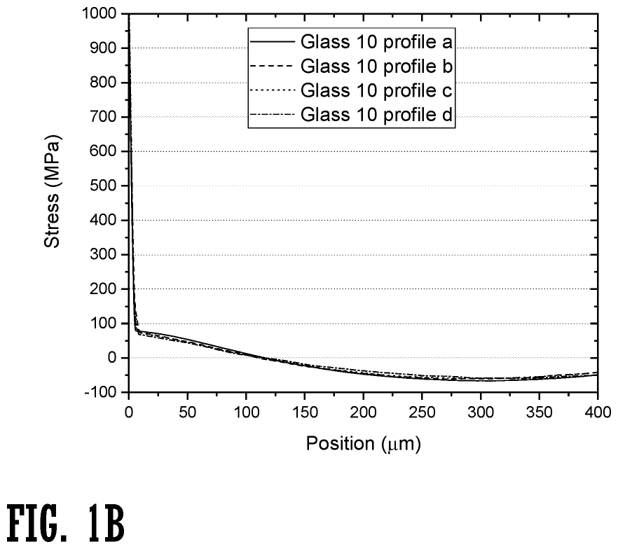

Some Exemplary Glasses were subjected to a single or double step ion exchange as described above. FIG. 1 shows an example of the stress profile of a resulting glass article after this kind of ion exchange.

TABLE 3
Exemplary Glass Compositions

| | | | | | | | | |
|---|---|---|---|---|---|---|---|---|
| Exemplary Glass | 1 | 2 | 3 | 4 | 5 | 6 | 7 | 8 |

Composition - mol. %

| | | | | | | | | | |
|---|---|---|---|---|---|---|---|---|---|
| SiO₂ | mol. % | 62.35 | 62.18 | 61.79 | 62.87 | 62.32 | 62.42 | 62.35 | 63.05 |
| Al₂O₃ | mol. % | 13.60 | 13.73 | 13.78 | 14.06 | 14.17 | 14.35 | 14.24 | 14.24 |
| Na₂O | mol. % | 12.71 | 8.33 | 8.92 | 8.17 | 8.39 | 8.44 | 8.47 | 8.37 |
| Li₂O | mol. % | 2.14 | 6.32 | 5.94 | 6.44 | 6.44 | 6.30 | 6.38 | 6.44 |
| B₂O₃ | mol. % | 0.50 | 4.98 | 4.87 | 4.15 | 4.42 | 4.32 | 4.35 | 3.60 |
| P₂O₅ | mol. % | 4.12 | 1.95 | 2.18 | 1.94 | 2.04 | 2.07 | 2.08 | 2.03 |
| MgO | mol. % | 3.27 | 1.86 | 1.90 | 1.71 | 1.56 | 1.46 | 1.49 | 1.60 |
| ZnO | mol. % | 0.20 | 0.36 | 0.34 | 0.33 | 0.29 | 0.27 | 0.28 | 0.31 |
| CaO | mol. % | 1.04 | 0.04 | 0.04 | 0.04 | 0.04 | 0.03 | 0.04 | 0.04 |
| K₂O | mol. % | 0.02 | 0.18 | 0.17 | 0.21 | 0.24 | 0.26 | 0.25 | 0.24 |
| SnO₂ | mol. % | 0.05 | 0.05 | 0.05 | 0.06 | 0.06 | 0.06 | 0.05 | 0.06 |
| Fe₂O₃ | mol. % | 0 | 0.02 | 0.02 | 0.02 | 0.02 | 0.02 | 0.02 | 0.02 |

Composition constraints

| | | | | | | | | | |
|---|---|---|---|---|---|---|---|---|---|
| Alk₂O/Al₂O₃ | mol. % | 1.093 | 1.080 | 1.091 | 1.054 | 1.063 | 1.045 | 1.060 | 1.057 |
| Li₂O + Na₂O | mol. % | 14.85 | 14.65 | 14.86 | 14.61 | 14.83 | 14.74 | 14.85 | 14.81 |
| Li₂O/Alk₂O | mol. % | 0.1439 | 0.4262 | 0.3952 | 0.4346 | 0.4274 | 0.4200 | 0.4225 | 0.4279 |

Measured properties

| | | | | | | |
|---|---|---|---|---|---|---|
| d_{RT} | g/cm³ | 2.395 | 2.396 | 2.393 | 2.394 | 2.391 |
| α₂₀₋₃₀₀ × 10₇ | K⁻¹ | 70.400 | 71.400 | 72.200 | 72.500 | 72.300 |
| E | GPa | 73.225 | 73.983 | 73.983 | 73.501 | 74.052 |
| G | GPa | 30.269 | 30.545 | 30.545 | 30.269 | 30.476 |
| μ | | 0.21000 | 0.21000 | 0.21100 | 0.21500 | 0.21400 |
| n_{d} | | 1.5036 | 1.5032 | 1.5033 | 1.5034 | 1.5035 |
| SOC | Brewster | 3.1560 | 3.1790 | 3.1660 | 3.2030 | 3.1850 |
| T_{liq} | ° C. | 980 | 975 | 985 | 990 | 995 |
| Str. P. | ° C. | 526 | 529 | 526 | 523 | 515 |
| An. P. | ° C. | 575 | 580 | 581 | 566 | 561 |
| T_{soft} | ° C. | 824 | 826 | 830 | 820 | 812 |
| T_{300 kP} | ° C. | 1008 | 1008 | 1018 | 1004 | 1011 |
| T_{160 kp} | ° C. | 1039 | 1040 | 1050 | 1035 | 1043 |
| T_{35 kP} | ° C. | 1125 | 1124 | 1135 | 1120 | 1128 |
| T_{200 P} | ° C. | 1583 | 1581 | 1589 | 1576 | 1584 |
| Log(η_{liq, P}) | P | 5.74 | 5.80 | 5.79 | 5.61 | 5.63 |
| T_{Zrbkdn} | ° C. | 1295 | 1285 | 1290 | 1305 | 1290 |

Predicted and calculated properties

| | | | | | | | | |
|---|---|---|---|---|---|---|---|---|
| Pₒₓ | 1.6616 | 1.4126 | 1.3513 | 0.89270 | 0.76355 | 0.36216 | 0.59561 | 0.73176 |
| P_{RO} | −0.10963 | −4.6698 | −4.7699 | −4.0144 | −4.5707 | −4.6224 | −4.6244 | −3.6782 |
| Pₒₓ − (1.5 + P_{RO}) | 0.2709 | 4.5833 | 4.6213 | 3.4079 | 3.8189 | 3.4707 | 3.7067 | 2.9097 |
| Pₒₓ − (0.5 + P_{RO}) | 1.2709 | 5.5833 | 5.6213 | 4.4079 | 4.8189 | 4.4707 | 4.7067 | 3.9097 |

| | | | | | | | | |
|---|---|---|---|---|---|---|---|---|
| Exemplary Glass | 9 | 10 | 11 | 12 | 13 | 14 | 15 | 16 |

Composition - mol. %

| | | | | | | | | | |
|---|---|---|---|---|---|---|---|---|---|
| SiO₂ | mol. % | 63.50 | 66.65 | 66.02 | 66.28 | 65.26 | 65.67 | 64.85 | 67.56 |
| Al₂O₃ | mol. % | 14.39 | 14.55 | 14.91 | 14.72 | 14.90 | 14.70 | 15.03 | 13.66 |
| Na₂O | mol. % | 7.96 | 6.12 | 6.72 | 6.40 | 7.57 | 7.28 | 7.87 | 6.03 |
| Li₂O | mol. % | 6.61 | 7.26 | 7.22 | 7.29 | 6.53 | 6.54 | 6.56 | 6.17 |
| B₂O₃ | mol. % | 3.18 | 1.13 | 0.91 | 1.01 | 0.88 | 0.96 | 0.82 | 1.39 |
| P₂O₅ | mol. % | 2.05 | 1.68 | 1.92 | 1.81 | 2.32 | 2.19 | 2.47 | 1.63 |
| MgO | mol. % | 1.64 | 1.86 | 1.60 | 1.75 | 1.87 | 1.99 | 1.75 | 2.85 |
| ZnO | mol. % | 0.32 | 0.41 | 0.32 | 0.37 | 0.33 | 0.36 | 0.29 | 0.62 |
| CaO | mol. % | 0.04 | 0.04 | 0.04 | 0.04 | 0.04 | 0.04 | 0.04 | 0 |
| K₂O | mol. % | 0.24 | 0.23 | 0.27 | 0.26 | 0.23 | 0.20 | 0.25 | 0 |
| SnO₂ | mol. % | 0.05 | 0.05 | 0.05 | 0.05 | 0.05 | 0.05 | 0.05 | 0.06 |
| Fe₂O₃ | mol. % | 0.02 | 0.02 | 0.02 | 0.02 | 0.02 | 0.02 | 0.02 | 0.02 |

Composition constraints

| | | | | | | | | | |
|---|---|---|---|---|---|---|---|---|---|
| Alk₂O/Al₂O₃ | mol. % | 1.029 | 0.9354 | 0.9531 | 0.9476 | 0.9616 | 0.9539 | 0.9767 | 0.8930 |
| Li₂O + Na₂O | mol. % | 14.57 | 13.38 | 13.94 | 13.69 | 14.10 | 13.82 | 14.43 | 12.20 |
| Li₂O/Alk₂O | mol. % | 0.4464 | 0.5334 | 0.5081 | 0.5226 | 0.4557 | 0.4664 | 0.4468 | 0.5058 |

Measured properties

| | | | | | | | | | |
|---|---|---|---|---|---|---|---|---|---|
| d_{RT} | g/cm³ | 2.394 | 2.400 | 2.401 | 2.400 | 2.403 | 2.401 | 2.405 | 2.392 |
| α₂₀₋₃₀₀ × 10⁷ | K⁻¹ | 70.500 | 62.800 | 66.300 | 64.400 | 67.600 | 66.500 | 69.300 | |
| E | GPa | 74.742 | 78.534 | 78.189 | 78.396 | 77.224 | 77.500 | 77.017 | 80.327 |
| G | GPa | 30.752 | 32.407 | 32.269 | 32.407 | 31.924 | 31.993 | 31.855 | 33.165 |
| μ | | 0.21400 | 0.21100 | 0.21200 | 0.21100 | 0.20900 | 0.21000 | 0.20800 | 0.21100 |
| n_{d} | | 1.504 | 1.5049 | 1.5048 | 1.5049 | 1.5034 | 1.5037 | 1.5034 | 1.5062 |
| SOC | Brewster | 3.1350 | 3.0450 | 3.0260 | 3.0410 | 3.0410 | 3.0510 | 3.0500 | 3.0810 |
| T_{liq} | ° C. | 1025 | 1120 | 1120 | 1100 | 1065 | 1075 | 1060 | 1180 |
| Str. P. | ° C. | 532 | 581 | 578 | 579 | 576 | 579 | 579 | 593 |
| An. P. | ° C. | 580 | 635 | 631 | 633 | 627 | 629 | 627 | 646 |
| T_{soft} | ° C. | 832 | 899 | 895 | 897 | 890 | 892 | 891 | 906 |
| T_{300 kP} | ° C. | 1027 | 1080 | 1085 | 1084 | 1080 | 1081 | 1079 | 1091 |
| T_{160 kP} | ° C. | 1058 | 1112 | 1117 | 1116 | 1112 | 1113 | 1111 | 1123 |
| T_{35 kP} | ° C. | 1144 | 1197 | 1203 | 1202 | 1198 | 1200 | 1197 | 1208 |
| T_{200 P} | ° C. | 1598 | 1642 | 1647 | 1648 | 1644 | 1648 | 1641 | 1658 |
| Log(I_{liq, P}) | P | 5.49 | 5.13 | 5.18 | 5.34 | 5.62 | 5.54 | 5.66 | 4.75 |
| T_{Zrbkdn} | ° C. | 1300 | 1330 | 1325 | 1330 | 1315 | 1330 | 1300 | |

Predicted and calculated properties

| Pₒₓ | | 0.37743 | −0.31506 | −0.65829 | −0.42785 | −0.66333 | −0.47693 | −0.73596 | 1.1742 |
|---|---|---|---|---|---|---|---|---|---|
| P_{RO} | | −3.2351 | −0.50776 | −0.86773 | −0.66774 | −0.96236 | −0.75420 | −1.2110 | 1.2877 |
| Pₒₓ − (1.5 + P_{RO}) | | 2.0984 | −1.3106 | −1.2895 | −1.2615 | −1.1927 | −1.218 | −1.0295 | −1.5718 |
| Pₒₓ − (0.5 + P_{RO}) | | 3.0984 | −0.3106 | −0.2895 | −0.2615 | −0.1927 | −0.2180 | −0.0295 | −0.5718 |
| Exemplary Glass | 17 | 18 | 19 | 20 | 21 | 22 | 23 | 24 | |

Composition - mol. %

| | | | | | | | | | |
|---|---|---|---|---|---|---|---|---|---|
| SiO₂ | mol. % | 68.23 | 68.92 | 67.26 | 66.88 | 66.20 | 65.44 | 65.05 | 64.66 |
| Al₂O₃ | mol. % | 13.49 | 13.33 | 13.56 | 13.83 | 13.99 | 14.23 | 14.35 | 14.46 |
| Na₂O | mol. % | 5.29 | 4.56 | 5.96 | 6.76 | 7.49 | 7.68 | 7.78 | 7.88 |
| Li₂O | mol. % | 6.58 | 6.99 | 6.59 | 5.75 | 5.35 | 5.22 | 5.14 | 5.08 |
| B₂O₃ | mol. % | 1.49 | 1.58 | 1.37 | 1.30 | 1.21 | 1.70 | 1.94 | 2.18 |
| P₂O₅ | mol. % | 1.31 | 0.98 | 1.63 | 1.96 | 2.29 | 2.29 | 2.29 | 2.29 |
| MgO | mol. % | 2.86 | 2.85 | 2.86 | 2.85 | 2.84 | 2.65 | 2.57 | 2.48 |
| ZnO | mol. % | 0.67 | 0.71 | 0.61 | 0.58 | 0.54 | 0.46 | 0.42 | 0.38 |
| CaO | mol. % | 0 | 0 | 0.04 | 0 | 0 | 0.15 | 0.24 | 0.31 |
| K₂O | mol. % | 0 | 0 | 0.04 | 0 | 0 | 0 | 0 | 0 |
| SrO | mol. % | 0 | 0 | 0 | 0 | 0 | 0.10 | 0.15 | 0.21 |
| SnO₂ | mol. % | 0.06 | 0.06 | 0.06 | 0.07 | 0.07 | 0.07 | 0.07 | 0.06 |
| Fe₂O₃ | mol. % | 0.02 | 0.02 | 0.02 | 0.02 | 0.01 | 0.01 | 0.01 | 0.01 |

Composition constraints

| | | | | | | | | | |
|---|---|---|---|---|---|---|---|---|---|
| Alk₂O/Al₂O₃ | mol. % | 0.8797 | 0.8666 | 0.9284 | 0.9045 | 0.9176 | 0.9066 | 0.9005 | 0.8961 |
| Li₂O + Na₂O | mol. % | 11.87 | 11.55 | 12.55 | 12.51 | 12.84 | 12.90 | 12.92 | 12.96 |
| Li₂O/Alk₂O | mol. % | 0.5543 | 0.6052 | 0.5234 | 0.4596 | 0.4166 | 0.4046 | 0.3978 | 0.3920 |

Measured properties

| | | | | | | | | | |
|---|---|---|---|---|---|---|---|---|---|
| d_{RT} | g/cm³ | 2.394 | 2.397 | 2.399 | 2.401 | 2.403 | 2.406 | 2.407 | 2.407 |
| E | GPa | 80.189 | 78.810 | 78.258 | 77.431 | 76.741 | 76.328 | 76.259 | 75.914 |
| G | GPa | 33.165 | 32.682 | 32.338 | 32.062 | 31.786 | 31.579 | 31.579 | 31.441 |
| μ | | 0.21000 | 0.20700 | 0.21000 | 0.20800 | 0.20900 | 0.20700 | 0.20800 | 0.20700 |
| n_{d} | | 1.5054 | 1.5046 | 1.504 | 1.503 | 1.5023 | | | |
| SOC | Brewster | 3.0950 | 3.1000 | 3.0910 | 3.0930 | 3.0980 | | | |
| T_{liq} | ° C. | 1170 | 1145 | | 1060 | 1040 | 1030 | 1025 | 1010 |
| Str. P | ° C. | 588 | 588 | 582 | 584 | 584 | 591 | 581 | 577 |
| An. P. | ° C. | 641 | 639 | 634 | 637 | 636 | 632 | 633 | 629 |
| T_{soft} | ° C. | 902 | | 898 | 899 | 899 | 899 | 897 | 897 |
| T_{300 kP} | ° C. | 1083 | 1092 | 1093 | 1085 | 1088 | 1086 | 1087 | 1090 |
| T_{160 kP} | ° C. | 1114 | 1124 | 1125 | 1116 | 1119 | 1118 | 1119 | 1122 |
| T_{35 kP} | ° C. | 1198 | 1212 | 1211 | 1201 | 1204 | 1203 | 1205 | 1207 |
| T_{200 P} | ° C. | 1641 | 1662 | 1658 | 1648 | 1646 | 1650 | 1647 | 1654 |
| Log(n_{lig, P}) | P | 4.75 | 5.12 | 5.55 | 5.71 | 5.94 | 6.02 | 6.09 | 6.26 |
| T_{Zrbkdn} | ° C. | 1435 | | | | | | 1335 | 1375 |

Predicted and calculated properties

| | | | | | | | | |
|---|---|---|---|---|---|---|---|---|
| Pₒₓ | 1.0472 | 0.80359 | 0.58102 | 0.30422 | 0.20529 | −0.0931 | −0.27893 | −0.46849 |
| P_{RO} | 1.0985 | 1.0037 | 0.60910 | 0.22947 | −0.02872 | −0.49952 | −0.69438 | −0.92883 |
| Pₒₓ − (1.5 + P_{RO}) | −1.6335 | −1.6982 | −1.101 | −1.5204 | −1.4428 | −1.0291 | −0.8372 | −0.6127 |
| Pₒₓ − (0.5 + P_{RO}) | −0.6335 | −0.6982 | −0.1010 | −0.5204 | −0.4428 | −0.0291 | 0.1628 | 0.3873 |

| | | | | | | | | |
|---|---|---|---|---|---|---|---|---|
| Exemplary Glass | 25 | 26 | 27 | 28 | 29 | 30 | 31 | 32 |

Composition - mol. %

| | | | | | | | | | |
|---|---|---|---|---|---|---|---|---|---|
| SiO₂ | mol. % | 65.92 | 65.77 | 65.63 | 69.34 | 70.08 | 67.50 | 67.45 | 67.48 |
| A₁₂O₃ | mol. % | 14.11 | 14.17 | 14.23 | 11.01 | 11.06 | 13.63 | 13.63 | 13.63 |
| Na₂O | mol. % | 7.18 | 7.01 | 6.86 | 6.18 | 5.50 | 5.99 | 6.01 | 6.00 |
| Li₂O | mol. % | 5.50 | 5.56 | 5.65 | 6.50 | 6.44 | 6.22 | 6.24 | 6.21 |
| B₂O₃ | mol. % | 1.76 | 2.04 | 2.31 | 0.46 | 0.48 | 1.39 | 1.40 | 1.39 |
| P₂O₅ | mol. % | 2.06 | 1.95 | 1.83 | 4.11 | 4.03 | 1.62 | 1.62 | 1.63 |
| MgO | mol. % | 2.65 | 2.57 | 2.47 | 1.66 | 1.66 | 2.87 | 2.87 | 2.87 |
| ZnO | mol. % | 0.49 | 0.46 | 0.44 | 0.44 | 0.42 | 0.62 | 0.61 | 0.62 |
| CaO | mol. % | 0.15 | 0.24 | 0.31 | 0.24 | 0.23 | 0.04 | 0.04 | 0.04 |
| K₂O | mol. % | 0 | 0 | 0 | 0 | 0.0028 | 0.04 | 0.04 | 0.04 |
| SrO | mol. % | 0.10 | 0.15 | 0.20 | 0 | 0 | 0 | 0 | 0 |
| SnO₂ | mol. % | 0.07 | 0.07 | 0.06 | 0.0614 | 0.0672 | 0.06 | 0.06 | 0.06 |
| TiO₂ | mol. % | 0 | 0 | 0 | 0.0083 | 0.0073 | 0.003 | 0.009 | 0.016 |
| Fe₂O₃ | mol. % | 0.01 | 0.01 | 0.01 | 0.0083 | 0.005 | 0.02 | 0.02 | 0.02 |
| SiCl₄ | mol. % | 0 | 0 | 0 | 0 | 0.0051 | 0 | 0 | 0 |

Composition constraints

| | | | | | | | | | |
|---|---|---|---|---|---|---|---|---|---|
| Alk₂O/Al₂O₃ | mol. % | 0.8985 | 0.8870 | 0.8790 | 1.152 | 1.079 | 0.8989 | 0.9016 | 0.8988 |
| Li₂O + Na₂O | mol. % | 12.68 | 12.57 | 12.51 | 12.68 | 11.94 | 12.21 | 12.25 | 12.21 |
| Li₂O/Alk₂O | mol. % | 0.4338 | 0.4423 | 0.4517 | 0.5125 | 0.5395 | 0.5077 | 0.5077 | 0.5069 |

Measured properties

| | | | | | | |
|---|---|---|---|---|---|---|
| d_{RT} | g/cm³ | 2.404 | 2.405 | 2.405 | | |
| E | GPa | 76.948 | 77.086 | 77.086 | | |
| G | GPa | 31.786 | 31.855 | 31.924 | | |
| μ | | 0.21000 | 0.21000 | 0.20700 | | |
| T_{liq} | ° C. | 1050 | 1050 | 1065 | | 1130 |
| Str. P. | ° C. | 580 | 579 | 578 | | |
| An. P. | ° C. | 632 | 632 | 631 | | 665 |
| T_{soft} | ° C. | 899 | 896 | 898 | | |
| T_{300 kP} | ° C. | 1087 | 1084 | 1090 | 1118 | |
| T_{160 kP} | ° C. | 1118 | 1116 | 1122 | 1154 | |
| T_{35 kP} | ° C. | 1204 | 1201 | 1209 | 1250 | |
| T_{200 P} | ° C. | 1648 | 1643 | 1657 | 1743 | |
| Log(n_{lig, P}) | P | 5.82 | 5.80 | 5.71 | | |
| T_{Zrbkdn} | ° C. | | 1390 | 1365 | | |

Predicted and calculated properties

| | | | | | | | | |
|---|---|---|---|---|---|---|---|---|
| Pₒₓ | −0.0787 | −0.12893 | −0.29870 | −0.10170 | −0.06529 | 0.53661 | 0.56127 | 0.51595 |
| P_{RO} | −0.31898 | −0.42232 | −0.53367 | −2.2317 | −2.1977 | 0.52122 | 0.50934 | 0.50221 |
| Pₒₓ − (1.5 + P_{RO}) | −1.0725 | −0.9112 | −0.7117 | 0.6297 | −0.1367 | −1.4877 | −1.4419 | −1.490 |
| Pₒₓ − (0.5 + P_{RO}) | −0.0725 | 0.0888 | 0.2883 | 1.6297 | 0.8633 | −0.4877 | −0.4419 | −0.4900 |

| | | | | | | | | |
|---|---|---|---|---|---|---|---|---|
| Exemplary Glass | 33 | 34 | 35 | 36 | 37 | 38 | 39 | 40 |

Composition - mol. %

| | | | | | | | | | |
|---|---|---|---|---|---|---|---|---|---|
| SiO₂ | mol. % | 67.43 | 67.43 | 67.17 | 65.93 | 65.73 | 67.52 | 67.73 | 67.82 |
| Al₂O₃ | mol. % | 13.62 | 13.61 | 13.52 | 14.71 | 14.73 | 13.60 | 13.56 | 13.54 |
| Na₂O | mol. % | 6.00 | 6.00 | 5.95 | 6.63 | 6.84 | 5.87 | 5.71 | 5.58 |
| Li₂O | mol. % | 6.29 | 6.26 | 6.28 | 7.35 | 7.19 | 6.36 | 6.42 | 6.48 |
| B₂O₃ | mol. % | 1.37 | 1.38 | 1.41 | 0.95 | 0.96 | 1.40 | 1.40 | 1.44 |
| P₂O₅ | mol. % | 1.62 | 1.63 | 1.62 | 1.91 | 2.03 | 1.57 | 1.51 | 1.44 |
| MgO | mol. % | 2.87 | 2.86 | 2.85 | 1.79 | 1.81 | 2.89 | 2.88 | 2.90 |
| ZnO | mol. % | 0.61 | 0.62 | 1.04 | 0.36 | 0.35 | 0.63 | 0.63 | 0.64 |
| CaO | mol. % | 0.04 | 0.04 | 0.04 | 0.04 | 0.04 | 0.04 | 0.04 | 0.04 |
| K₂O | mol. % | 0.04 | 0.04 | 0.04 | 0.25 | 0.24 | 0.04 | 0.04 | 0.04 |
| SnO₂ | mol. % | 0.06 | 0.06 | 0.06 | 0.06 | 0.06 | 0.06 | 0.06 | 0.06 |
| TiO₂ | mol. % | 0.033 | 0.055 | 0 | 0 | 0 | 0 | 0 | 0 |
| Fe₂O₃ | mol. % | 0.02 | 0.02 | 0.02 | 0.02 | 0.02 | 0.02 | 0.02 | 0.02 |

Composition constraints

| | | | | | | | | | |
|---|---|---|---|---|---|---|---|---|---|
| Alk₂O/Al₂O₃ | mol. % | 0.9051 | 0.9040 | 0.9078 | 0.9674 | 0.9690 | 0.9022 | 0.8974 | 0.8937 |
| Li₂O + Na₂O | mol. % | 12.29 | 12.26 | 12.23 | 13.98 | 14.03 | 12.23 | 12.13 | 12.06 |
| Li₂O/Alk₂O | mol. % | 0.5101 | 0.5090 | 0.5118 | 0.5165 | 0.5039 | 0.5184 | 0.5275 | 0.5356 |

Measured properties

| | | | | | | |
|---|---|---|---|---|---|---|
| d_{RT} | g/cm³ | 2.401 | 2.401 | 2.399 | 2.398 | 2.398 |
| α₂₀₋₃₀₀ × 10⁷ | K⁻¹ | 64.700 | 66.000 | 58.400 | 57.800 | 57.200 |
| E | GPa | 77.914 | 77.800 | 78.400 | 78.500 | 78.740 |
| G | GPa | 32.200 | 32.200 | 32.300 | 32.400 | 32.410 |
| μ | | 0.21000 | 0.21000 | 0.21300 | 0.21100 | 0.21400 |
| n_{d} | | 1.5047 | | 1.5041 | 1.5042 | 1.5045 |
| SOC | Brewster | 3.0500 | 3.0540 | 3.0910 | 3.0890 | 3.0930 |
| T_{lig} | ° C. | 1125 | 1105 | 1115 | 1120 | 1100 |
| Str. P. | ° C. | 577 | 574 | 583 | 583 | 585 |
| An. P. | ° C. | 631 | 629 | 637 | 637 | 638 |
| T_{soft} | ° C. | 893 | 892 | 899 | 899 | 903 |
| T_{300 kP} | ° C. | 1083 | | | | |
| T_{160 kP} | ° C. | 1115 | | | | |
| T_{35 kP} | ° C. | 1200 | 1202 | 1204 | 1207 | 1209 |
| T_{200 P} | ° C. | 1643 | 1648 | 1654 | 1656 | 1656 |
| Log(η_{lig, P}) | P | 5.12 | | | | |

Predicted and calculated properties

| | | | | | | | | |
|---|---|---|---|---|---|---|---|---|
| Pₒₓ | 0.60437 | 0.57961 | 1.0582 | −0.21409 | −0.28640 | 0.65976 | 0.64893 | 0.70126 |
| P_{RO} | 0.53230 | 0.51314 | 0.90736 | −0.68054 | −0.79012 | 0.58989 | 0.63948 | 0.70062 |
| Pₒₓ − (1.5 + P_{RO}) | −1.4228 | −1.4269 | −1.3371 | −1.0298 | −0.9963 | −1.4301 | −1.4906 | −1.4994 |
| Pₒₓ − (0.5 + P_{RO}) | −0.4228 | −0.4269 | −0.3371 | −0.0298 | 0.0037 | −0.4301 | −0.4906 | −0.4994 |

| | | | |
|---|---|---|---|
| Exemplary Glass | 41 | 42 | 43 |

Composition - mol. %

| | | | | |
|---|---|---|---|---|
| SiO₂ | mol. % | 67.05 | 66.67 | 66.79 |
| Al₂O₃ | mol. % | 13.89 | 14.13 | 14.07 |
| Na₂O | mol. % | 6.19 | 6.39 | 6.35 |
| Li₂O | mol. % | 6.48 | 6.64 | 6.57 |
| B₂O₃ | mol. % | 1.28 | 1.20 | 1.20 |
| P₂O₅ | mol. % | 1.73 | 1.81 | 1.79 |
| MgO | mol. % | 2.62 | 2.41 | 2.48 |
| ZnO | mol. % | 0.55 | 0.50 | 0.52 |
| CaO | mol. % | 0.04 | 0.04 | 0.04 |
| K₂O | mol. % | 0.09 | 0.13 | 0.11 |
| SnO₂ | mol. % | 0.06 | 0.06 | 0.06 |
| Fe₂O₃ | mol. % | 0.02 | 0.02 | 0.02 |

Composition constraints

| | | | | |
|---|---|---|---|---|
| Alk₂O/Al₂O₃ | mol. % | 0.9186 | 0.9313 | 0.9260 |
| Li₂O + Na₂O | mol. % | 12.67 | 13.03 | 12.92 |
| Li₂O/Alk₂O | mol. % | 0.5078 | 0.5046 | 0.5043 |

Measured properties

| | | | | |
|---|---|---|---|---|
| d_{RT} | g/cm³ | 2.399 | 2.400 | 2.400 |
| α₂₀₋₃₀₀ × 10₇ | K⁻¹ | 60.600 | 61.700 | 61.600 |
| E | GPa | 78.120 | 78.051 | 78.051 |
| G | GPa | 32.200 | 32.269 | 32.269 |
| μ | | 0.21200 | 0.21100 | 0.20900 |
| n_{d} | | 1.504 | 1.5041 | 1.5042 |
| SOC | Brewster | 3.0850 | 3.0640 | 3.0700 |
| T_{liq} | ° C. | 1105 | 1110 | 1095 |
| Str. P. | ° C. | 581 | 581 | 579 |
| An. P. | ° C. | 634 | 634 | 633 |
| T_{soft} | ° C. | 902 | 898 | 896 |
| T_{300 kP} | ° C. | | 1083 | 1087 |
| T_{160 kP} | ° C. | | 1115 | 1119 |
| T_{35 kP} | ° C. | 1204 | 1200 | 1205 |
| T_{200 P} | ° C. | 1652 | 1647 | 1648 |
| Log(η_{liq, P}) | P | | 5.24 | 5.41 |

Predicted and calculated properties

| | | | |
|---|---|---|---|
| Pₒₓ | 0.34883 | 0.18185 | 0.21409 |
| P_{RO} | 0.19939 | −0.04583 | 0.04824 |
| Pₒₓ − (1.5 + P_{RO}) | −1.3506 | −1.2712 | −1.3416 |
| Pₒₓ − (0.5 + P_{RO}) | −0.3506 | −0.2712 | −0.3416 |

Table 4 below lists the glass compositions and properties for Comparative Glasses C1-C2.

TABLE 4
Compositions and Properties of Comparative Example Glasses

Comparative Examples

| | |
|---|---|
| C1 | C2 |

Reference

| | |
|---|---|
| [2] | [1] |

Composition - mol. %

| | | | |
|---|---|---|---|
| SiO₂ | mol. % | 69.09 | 61.85 |
| Al₂O₃ | mol. % | 13.50 | 14.87 |
| Na₂O | mol. % | 6.40 | 7.19 |
| Li₂O | mol. % | 6.91 | 7.66 |
| B₂O₃ | mol. % | 2.40 | 2.38 |
| MgO | mol. % | 1.30 | 3.47 |
| SnO₂ | mol. % | 0.20 | 0 |
| P₂O₅ | mol. % | 0.20 | 0 |
| SiF₄ | mol. % | 0 | 1.84 |
| SiCl₄ | mol. % | 0 | 0.49 |
| SiBr₄ | mol. % | 0 | 0.13 |
| Ag₂O | mol. % | 0 | 0.11 |
| CuO | mol. % | 0 | 0.0167 |

Measured properties

| | | |
|---|---|---|
| d_{RT} | g/cm³ | 2.370 |
| α₂₀₋₃₀₀ × 10⁷ | K⁻¹ | 59.400 |
| E | GPa | 77.500 |

The reference key for each of the Comparative Glasses listed in Table 4 is as follows: [1] U.S. Pat. No. 3,656,923A; [2] WO2021053695A1.

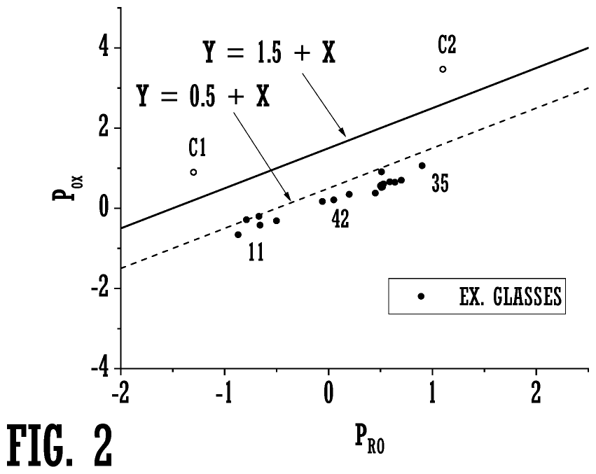

FIG. 2 is a plot showing the relationship between the RO balance parameter P_{RO} and the oxygen balance parameter Pₒₓ for some of the Exemplary Glasses and some of the Comparative Glasses. The Exemplary Glasses (filled circles) are the Examples 10 to 12, 16, 19 and 30 to 43 from Table 3. Selected Examples 11, 42 and 35 are labeled with reference numbers on FIG. 2. The Comparative Glasses (open circles) are the Examples C1 and C2 from Table 4. All of the Exemplary Glasses and Comparative Glasses shown in FIG. 2 have the features specified in Table 5. In Table 5, the specification “Not limited”, if appears, refers to a limitation that was not considered when selecting the compositions. In FIG. 2, some of the above-enumerated compositions may be labeled for better visibility, some others may not, and some more glasses may not be shown, which does not affect the further conclusions.

TABLE 5
Limitations for glass compositions shown in FIG. 2

| Quantity | Unit | Min | Max |
|---|---|---|---|
| SiO₂ | mol. % | 58 | 69.9 |
| Na₂O | mol. % | 3 | 10 |
| Li₂O | mol. % | 3 | 7.95 |
| Al₂O₃ | mol. % | 1 | 20 |
| MgO | mol. % | 0 | 4.8 |
| ZnO | mol. % | 0 | 4 |
| CaO | mol. % | 0 | 2.5 |
| TiO₂ | mol. % | 0 | 1 |
| ZrO₂ | mol. % | 0 | 1 |
| SnO₂ | mol. % | 0 | 0.5 |
| BaO | mol. % | 0 | 0.5 |
| K₂O | mol. % | 0 | 0.5 |
| Alk₂O | mol. % | 9 | 17.5 |
| REₘOₙ | mol. % | 0 | 1.5 |
| Li₂O + Na₂O | mol. % | 12 | 17.5 |
| Li₂O/Alk₂O | mol. % | 0.5 | 0.55 |
| Alk₂O/Al₂O₃ | mol. % | 0.85 | 1 |
| P_{RO} | | −2 | 2 |

The above-enumerated Comparative Glasses were selected as having the lowest measured values of the oxygen balance parameter Pₒₓ at comparable values of the RO balance parameter P_{RO} among the known glasses that have the mentioned features specified in Table 5.

The line corresponding to the formula y=1.5+x shown in FIG. 2 provides a visual representation of the differences between the Comparative Glasses having the features specified in Table 5 and the Exemplary Glasses 10 to 12, 16, 19 and 30 to 43 according to the present disclosure. As can be seen in FIG. 2, the mentioned Exemplary Glasses (filled circles) and none of the Comparative Glasses (open circles) represented in FIG. 2 fall above the line y=1.5+x, where y corresponds to Pₒₓ and x corresponds to P_{RO}. In other words, some of the Exemplary Glasses and none of the Comparative Glasses represented in FIG. 2 satisfy the following formula (III)(a):

Pₒₓ−(1.5+P_{RO})<0.00 (III)(a)

As can also be seen in FIG. 2, some of Exemplary Glasses and none of the Comparative Glasses represented in FIG. 2 fall above the line y=0.5+x, where y corresponds to Pₒₓ and x corresponds to P_{RO}. In other words, the said Exemplary Glasses and none of the Comparative Glasses represented in FIG. 2 satisfy the following formula (III)(b):

Pₒₓ−(0.5+P_{RO})<0.00 (III)(b)

The Exemplary Examples represented in FIG. 2 that satisfy the formula (III)(b) are characterized by the lowest values of Pₒₓ at comparable values of P_{RO} among the glasses that have the features specified in Table 5.

This means that, under the conditions specified in Table 5 above, some of the Exemplary Glasses have lower measured values of the oxygen balance parameter Pₒₓ at comparable measured values of the RO balance parameter P_{RO} than the best of the Comparative Glasses satisfying the same conditions. This can be interpreted as these Exemplary Glasses, according to measurements, have lower values of Pₒₓ at comparable values of P_{RO} among the said glasses, i.e. they are, according to measurement, superior in terms of combination of P_{RO} and Pₒₓ to the best known Comparative Glasses that have the features specified in Table 5.

The values of all attributes specified in Table 5 and Formulas (III)(a) and (III)(b) for the Comparative Glasses C1 and C2 plotted in FIG. 2 are presented in Table 6 below. Full compositions of comparative example glasses are presented in Table 4. Full compositions and above-mentioned attributes of the Exemplary Glasses from the present disclosure are presented in Table 3.

TABLE 6
Attributes of Comparative Example Glasses
Having the Features Specified in Table 5

Ex. #

| | |
|---|---|
| C1 | C2 |

Composition

| | | | |
|---|---|---|---|
| Alk₂O | mol. % | 13.30 | 14.85 |
| Na₂O | mol. % | 6.40 | 7.19 |
| Li₂O | mol. % | 6.90 | 7.66 |
| Al₂O₃ | mol. % | 13.50 | 14.87 |
| MgO | mol. % | 1.30 | 3.47 |
| ZnO | mol. % | 0 | 0 |
| CaO | mol. % | 0 | 0 |
| REₘOₙ | mol. % | 0 | 0 |
| TiO₂ | mol. % | 0 | 0 |
| ZrO₂ | mol. % | 0 | 0 |
| SnO₂ | mol. % | 0.20 | 0 |
| BaO | mol. % | 0 | 0 |
| K₂O | mol. % | 0 | 0 |
| Li₂O + Na₂O | mol. % | 13.30 | 14.85 |

Measured properties

| | | |
|---|---|---|
| P_{RO} | −1.300 | 1.1008 |
| Pₒₓ | 0.900 | 3.468 |

Composition

| | | | |
|---|---|---|---|
| Li₂O/Alk₂O | mol. % | 0.5188 | 0.5161 |
| Alk₂O/Al₂O₃ | mol. % | 0.9852 | 0.9987 |
| Pₒₓ − (1.5 + P_{RO}) | | 0.700 | 0.8672 |
| Pₒₓ − (0.5 + P_{RO}) | | 1.700 | 1.8672 |

The following non-limiting aspects are encompassed by the present disclosure. To the extent not already described, any one of the features of the first through the thirty-third aspect may be combined in part or in whole with features of any one or more of the other aspects of the present disclosure to form additional aspects, even if such a combination is not explicitly described.

According to a first aspect, the glass comprises a plurality of components, the glass having a composition of the components comprising greater than or equal to 60.0 mol. % and less than or equal to 70.0 mol. % SiO₂, greater than or equal to 5.0 mol. % and less than or equal to 20.0 mol. % Al₂O₃, greater than or equal to 1.2 mol. % and less than or equal to 4.0 mol. % MgO, greater than or equal to 0.5 mol. % and less than or equal to 10.0 mol. % Li₂O, greater than or equal to 0.45 mol. % and less than or equal to 6 mol. % P₂O₂, greater than or equal to 0.0 mol. % and less than or equal to 15.0 mol. % Na₂O, greater than or equal to 0.0 mol. % and less than or equal to 5.0 mol. % B₂O₃, greater than or equal to 0.0 mol. % and less than or equal to 1.0 mol. % ZnO, greater than or equal to 0.0 mol. % and less than or equal to 0.5 mol. % K₂O, less than or equal to 16.0 mol. % Alk₂O and greater than or equal to 0.0 mol. % and less than or equal to 1.5 mol. % REₘOₙ and wherein the composition of the components satisfies the conditions: 0.85≤Alk₂O/Al₂O₃ [mol. %]≤1.2, where chemical formulas mean the content of corresponding components in the glass in mol %, Alk₂O is a total sum of alkali metal oxides Li₂O+Na₂O+K₂O+Rb₂O+Cs₂O, and REₘOₙ is a total sum of rare earth metal oxides, La₂O₃+Y₂O₃+Gd₂O₃+Yb₂O₃+Lu₂O₃+Ce₂O₃+Pr₂O₃+Nd₂O₃+Sm₂O₃+Eu₂O₃+Tb₂O₃+Dy₂O₃+Ho₂O₃+Er₂O₃+Tm₂O₃.

According to a second aspect, the glass of the first aspect, wherein the composition of the components comprises greater than or equal to 12.0 mol. % and less than or equal to 18.0 mol. % Al₂O₃, greater than or equal to 2.0 mol. % and less than or equal to 8.0 mol. % Li₂O, greater than or equal to 0.45 mol. % and less than or equal to 4 mol. % P₂O₅, greater than or equal to 0.3 mol. % and less than or equal to 15.0 mol. % Na₂O, greater than or equal to 0 mol. % and less than or equal to 0.75 mol. % ZnO, less than or equal to 15.5 mol. % Alk₂O and greater than or equal to 0.0 mol. % and less than or equal to 0.3 mol. % REₘOₙ and wherein the composition of the components satisfies the conditions: 0.85≤Alk₂O/Al₂O₃ [mol. %]≤1.09.

According to a third aspect, the glass of any one of aspects 1-2, wherein the composition of the components satisfies the conditions: 0.9≤Alk₂O/Al₂O₃ [mol. %]≤1.1.

According to a fourth aspect, the glass of any one of aspects 1-3, wherein the composition of the components satisfies the conditions: 0.85≤Alk₂O/Al₂O₃ [mol. %]≤0.96.

According to a fifth aspect, the glass of any one of aspects 1-4, wherein the composition of the components comprises greater than or equal to 12.0 mol. % and less than or equal to 18.0 mol. % Al₂O₃, greater than or equal to 2.0 mol. % and less than or equal to 8.0 mol. % Li₂O, greater than or equal to 0.45 mol. % and less than or equal to 4 mol. % P₂O₅, greater than or equal to 0.3 mol. % and less than or equal to 15.0 mol. % Na₂O, greater than or equal to 0 mol. % and less than or equal to 0.75 mol. % ZnO, less than or equal to 15.5 mol. % Alk₂O and greater than or equal to 0.0 mol. % and less than or equal to 0.3 mol. % REₘOₙ and wherein the composition of the components satisfies the conditions: 0.85≤Alk₂O/Al₂O₃ [mol. %]≤1.09.

According to a sixth aspect, the glass of any one of aspects 1-5, wherein the composition of the components comprises greater than or equal to 10.0 mol. % and less than or equal to 17.5 mol. % Al₂O₃, greater than or equal to 0.5 mol. % and less than or equal to 7.5 mol. % Li₂O, greater than or equal to 0.45 mol. % and less than or equal to 4 mol. % P₂O₅ and greater than or equal to 0.3 mol. % and less than or equal to 15.0 mol. % Na₂O.

According to a seventh aspect, the glass of any one of aspects 1-6, wherein the composition of the components comprises one or more of the following components: greater than or equal to 62.0 mol. % and less than or equal to 69.5 mol. % SiO₂, greater than or equal to 11.5 mol. % and less than or equal to 16.5 mol. % Al₂O₃, greater than or equal to 2.5 mol. % and less than or equal to 7.5 mol. % Li₂O, greater than or equal to 2.0 mol. % and less than or equal to 11.5 mol. % Na₂O, greater than or equal to 1.2 mol. % and less than or equal to 3.1 mol. % MgO, greater than or equal to 0.45 mol. % and less than or equal to 3.7 mol. % P₂O₅, greater than or equal to 0.4 mol. % and less than or equal to 4.6 mol. % B₂O₃, greater than or equal to 0.1 mol. % and less than or equal to 0.9 mol. % ZnO, greater than or equal to 0 mol. % and less than or equal to 0.95 mol. % CaO and greater than or equal to 0 mol. % and less than or equal to 0.475 mol. % TiO₂.

According to an eighth aspect, the glass of any one of aspects 1-7, wherein the composition of the components comprises greater than or equal to 62.8 mol. % and less than or equal to 68.5 mol. % SiO₂, greater than or equal to 12.2 mol. % and less than or equal to 15.8 mol. % Al₂O₃, greater than or equal to 3.2 mol. % and less than or equal to 7.2 mol. % Li₂O, greater than or equal to 3.0 mol. % and less than or equal to 10.5 mol. % Na₂O, greater than or equal to 1.45 mol. % and less than or equal to 2.85 mol. % MgO, greater than or equal to 0.8 mol. % and less than or equal to 4.0 mol. % B₂O₃, greater than or equal to 0.8 mol. % and less than or equal to 3.3 mol. % P₂O₅, greater than or equal to 0.200 mol. % and less than or equal to 0.825 mol. % ZnO, greater than or equal to 0 mol. % and less than or equal to 0.85 mol. % CaO and greater than or equal to 0 mol. % and less than or equal to 0.42 mol. % TiO₂.

According to a ninth aspect, the glass of any one of aspects 1-8, wherein the composition of the components comprises greater than or equal to 7.05 mol. % and less than or equal to 7.75 mol. % Li₂O.

According to a tenth aspect, the glass of any one of aspects 1-9, wherein the composition of the components comprises greater than or equal to 0.0 mol. % and less than or equal to 0.5 mol. % GeO₂, greater than or equal to 0.0 at. % and less than or equal to 0.2 at. % Cl, a sum of La₂O₃+Y₂O₃ is greater than or equal to 0.0 mol. % and less than or equal to 0.2 mol. %, wherein the composition of the components is substantially free of arsenic, substantially free of fluorine and substantially free of PbO.

According to an eleventh aspect, the glass of any one of aspects 1-10, wherein the composition of the components comprises a sum of MgO+CaO+SrO+BaO+ZnO is greater than or equal to 0.0 mol. % and less than or equal to 10.0 mol. % and wherein the composition of the components satisfies the conditions: (MgO+CaO+ZnO)/RO [mol. %]≥0.80, where chemical formulas mean the content of corresponding components in the glass, RO is a total sum of divalent metal oxides.

According to a twelfth aspect, the glass of any one of aspects 1-11, wherein the composition of the components comprises a sum of SiO₂+Al₂O₃+B₂O₃+P₂O₅+Li₂O+Na₂O+MgO is greater than or equal to 98.0 mol. %.

According to a thirteenth aspect, the glass of any one of aspects 1-12, wherein the glass has Young's modulus, E that is greater than or equal to 70 GPa.

According to a fourteenth aspect, the glass of any one of aspects 1-13, wherein the glass has decimal logarithm of liquidus viscosity, Log(η_{liq}, P) that is greater than or equal to 5.0 P.

According to a fifteenth aspect, the glass of any one of aspects 1-14, wherein the glass has decimal logarithm of liquidus viscosity, Log(η_{liq}, P) that is greater than or equal to 5.1 P.

According to a sixteenth aspect, the glass of the fifteenth aspect, wherein the glass has decimal logarithm of liquidus viscosity, Log(η_{liq}, P) that is greater than or equal to 5.3 P.

According to a seventeenth aspect, the glass comprises a plurality of components, the glass having a composition of the components comprising greater than or equal to 58.0 mol. % and less than or equal to 69.9 mol. % SiO₂, greater than or equal to 3.0 mol. % and less than or equal to 10.0 mol. % Na₂O, greater than or equal to 3 mol. % and less than or equal to 7.95 mol. % Li₂O, greater than or equal to 1.0 mol. % and less than or equal to 20.0 mol. % Al₂O₃, greater than or equal to 0.0 mol. % and less than or equal to 4.8 mol. % MgO, greater than or equal to 0.0 mol. % and less than or equal to 4.0 mol. % ZnO, greater than or equal to 0.0 mol. % and less than or equal to 2.5 mol. % CaO, greater than or equal to 0.0 mol. % and less than or equal to 1.0 mol. % TiO_{2,} greater than or equal to 0.0 mol. % and less than or equal to 1.0 mol. % ZrO₂, greater than or equal to 0.0 mol. % and less than or equal to 0.5 mol. % SnO₂, greater than or equal to 0.0 mol. % and less than or equal to 0.5 mol. % BaO, greater than or equal to 0.0 mol. % and less than or equal to 0.5 mol. % K₂O, greater than or equal to 9.0 mol. % and less than or equal to 17.5 mol. % Alk₂O, greater than or equal to 0.0 mol. % and less than or equal to 1.5 mol. % REₘOₙ, a sum of Li₂O +Na₂O is greater than or equal to 12.0 mol. % and less than or equal to 17.5 mol. %, wherein the composition of the components satisfies the conditions: 0.50≤Li₂O/Alk₂O [mol. %]≤0.55 and 0.85≤Alk₂O/Al₂O₃ [mol. %]≤1, Pₒₓ−(1.5+P_{RO})<0.000, and P_{RO} greater than or equal to −2 and less than or equal to 2, wherein: P_{RO} is a value of RO balance parameter, calculated from the glass composition in terms of mol. % of the components according to the Formula (II):

P_{RO}=(MgO+CaO+ZnO)−(B₂O₃+P₂O₅), (II)

Pₒₓ is a value of oxygen balance parameter, calculated from the glass composition in terms of mol. % of the components according to the Formula (I):

Pₒₓ=(Alk₂O+RO)−(Al₂O₃+P₂O₅), (I)

chemical formulas mean the content of corresponding components in the glass in mol %, Alk₂O is a total sum of alkali metal oxides, Li₂O+Na₂O+K₂O+Rb₂O+Cs₂O, and REₘOₙ is a total sum of rare earth metal oxides, La₂O₃+Y₂O₃+Gd₂O₃+Yb₂O₃+Lu₂O₃+Ce₂O₃+Pr₂O₃+Nd₂O₃+Sm₂O₃+Eu₂O₃+Tb₂O₃+Dy₂O₃+HO₂O₃+Er₂O₃+Tm₂O₃, and RO is the total sum of MgO+CaO+SrO+BaO+ZnO.

According to an eighteenth aspect, the glass of the seventeenth aspect, wherein the glass satisfies the conditions: Pₒₓ−(0.5+P_{RO})<0.000, where Pₒₓ is a value of oxygen balance parameter, calculated from the glass composition in terms of mol. % of the components according to the Formula (I):

Pₒₓ=(Alk₂O+RO)−(Al₂O₃+P₂O₅), (I)

P_{RO} is a value of RO balance parameter, calculated from the glass composition in terms of mol. % of the components according to the Formula (II):

P_{RO}=(MgO+CaO+ZnO)−(B₂O₃+P₂O₅), (II)

According to a nineteenth aspect, the glass of any one of aspects 17-18, wherein the composition of the components comprises greater than or equal to 60.0 mol. % and less than or equal to 69.9 mol. % SiO₂, greater than or equal to 12.0 mol. % and less than or equal to 18.0 mol. % Al₂O₃, greater than or equal to 1.2 mol. % and less than or equal to 4.0 mol. % MgO, greater than or equal to 0.3 mol. % and less than or equal to 4.0 mol. % P₂O₅, greater than or equal to 0.0 mol. % and less than or equal to 5.0 mol. % B₂O₃, greater than or equal to 0 mol. % and less than or equal to 0.75 mol. % ZnO, less than or equal to 15.5 mol. % Alk₂O and greater than or equal to 0.0 mol. % and less than or equal to 0.3 mol. % REₘOₙ.

According to a twentieth aspect, the glass of any one of aspects 17-19, wherein the composition of the components satisfies the conditions: 0.9≤Alk₂O/Al₂O₃ [mol. %]≤1.0.

According to a twenty-first aspect, the glass of any one of aspects 17-20, wherein the composition of the components satisfies the conditions: 0.85≤Alk₂O/Al₂O₃ [mol. %]≤0.96.

According to a twenty-second aspect, the glass of any one of aspects 17-21, wherein the composition of the components comprises greater than or equal to 60.0 mol. % and less than or equal to 69.9 mol. % SiO₂, greater than or equal to 12.0 mol. % and less than or equal to 18.0 mol. % Al₂O₃, greater than or equal to 1.2 mol. % and less than or equal to 4.0 mol. % MgO, greater than or equal to 0.3 mol. % and less than or equal to 4.0 mol. % P₂O₅, greater than or equal to 0.0 mol. % and less than or equal to 5.0 mol. % B₂O₃, greater than or equal to 0 mol. % and less than or equal to 0.75 mol. % ZnO, less than or equal to 15.5 mol. % Alk₂O and greater than or equal to 0.0 mol. % and less than or equal to 0.3 mol. % REₘOₙ.

According to a twenty-third aspect, the glass of any one of aspects 17-22, wherein the composition of the components comprises greater than or equal to 60.0 mol. % and less than or equal to 69.9 mol. % SiO₂, greater than or equal to 10.0 mol. % and less than or equal to 17.5 mol. % Al₂O₃, greater than or equal to 3.0 mol. % and less than or equal to 7.5 mol. % Li₂O, greater than or equal to 1.2 mol. % and less than or equal to 4.0 mol. % MgO, greater than or equal to 0.0 mol. % and less than or equal to 5.0 mol. % B₂O₃, greater than or equal to 0.0 mol. % and less than or equal to 4.0 mol. % P₂O₅ and greater than or equal to 0.0 mol. % and less than or equal to 1.0 mol. % ZnO.

According to a twenty-fourth aspect, the glass of any one of aspects 17-23, wherein the composition of the components comprises one or more of the following components: greater than or equal to 62.0 mol. % and less than or equal to 69.5 mol. % SiO₂, greater than or equal to 11.5 mol. % and less than or equal to 16.5 mol. % Al₂O₃, greater than or equal to 3.0 mol. % and less than or equal to 7.5 mol. % Li₂O, greater than or equal to 1.2 mol. % and less than or equal to 3.1 mol. % MgO, greater than or equal to 0.4 mol. % and less than or equal to 4.6 mol. % B₂O₃, greater than or equal to 0.4 mol. % and less than or equal to 3.7 mol. % P₂O₅, greater than or equal to 0.1 mol. % and less than or equal to 0.9 mol. % ZnO, greater than or equal to 0 mol. % and less than or equal to 0.95 mol. % CaO and greater than or equal to 0 mol. % and less than or equal to 0.475 mol. % TiO₂.

According to a twenty-fifth aspect, the glass of any one of aspects 17-24, wherein the composition of the components comprises greater than or equal to 62.8 mol. % and less than or equal to 68.5 mol. % SiO₂, greater than or equal to 12.2 mol. % and less than or equal to 15.8 mol. % Al₂O₃, greater than or equal to 3.2 mol. % and less than or equal to 7.2 mol. % Li₂O, greater than or equal to 1.45 mol. % and less than or equal to 2.85 mol. % MgO, greater than or equal to 0.8 mol. % and less than or equal to 4.0 mol. % B₂O₃, greater than or equal to 0.8 mol. % and less than or equal to 3.3 mol. % P₂O₅, greater than or equal to 0.200 mol. % and less than or equal to 0.825 mol. % ZnO, greater than or equal to 0 mol. % and less than or equal to 0.85 mol. % CaO and greater than or equal to 0 mol. % and less than or equal to 0.42 mol. % TiO_{2.}

According to a twenty-sixth aspect, the glass of any one of aspects 17-25, wherein the composition of the components comprises greater than or equal to 7.05 mol. % and less than or equal to 7.75 mol. % Li₂O.

According to a twenty-seventh aspect, the glass of any one of aspects 17-26, wherein the composition of the components comprises greater than or equal to 0.0 mol. % and less than or equal to 0.5 mol. % GeO₂, greater than or equal to 0.0 at. % and less than or equal to 0.2 at. % Cl, a sum of La₂O₃+Y₂O₃ is greater than or equal to 0.0 mol. % and less than or equal to 0.2 mol. %, wherein the composition of the components is substantially free of arsenic, substantially free of fluorine and substantially free of PbO.

According to a twenty-eighth aspect, the glass of any one of aspects 17-27, wherein the composition of the components comprises a sum of MgO+CaO+SrO+BaO+ZnO is greater than or equal to 0.0 mol. % and less than or equal to 10.0 mol. % and wherein the composition of the components satisfies the conditions: (MgO+CaO+ZnO)/RO [mol. %]>0.80, where chemical formulas mean the content of corresponding components in the glass, RO is a total sum of divalent metal oxides.

According to a twenty-ninth aspect, the glass of any one of aspects 17-28, wherein the composition of the components comprises a sum of SiO₂+Al₂O₃+B₂O₃+P₂O₅+Li₂O+Na₂O+MgO is greater than or equal to 98.0 mol. %.

According to a thirtieth aspect, the glass of any one of aspects 17-29, wherein the glass has Young's modulus, E that is greater than or equal to 70 GPa.

According to a thirty-first aspect, the glass of any one of aspects 17-30, wherein the glass has decimal logarithm of liquidus viscosity, Log(η_{liq}, P) that is greater than or equal to 5.0 P.

According to a thirty-second aspect, the glass of any one of aspects 17-31, wherein the glass has decimal logarithm of liquidus viscosity, Log(η_{liq}, P) that is greater than or equal to 5.1 P.

According to a thirty-third aspect, the glass of the thirty-second aspect, wherein the glass has decimal logarithm of liquidus viscosity, Log(η_{liq}, P) that is greater than or equal to 5.3 P.

Many variations and modifications may be made to the above-described embodiments of the disclosure without departing substantially from the spirit and various principles of the disclosure. All such modifications and variations are intended to be included herein within the scope of this disclosure and protected by the following claims.

To the extent not already described, the different features of the various aspects of the present disclosure may be used in combination with each other as desired. That a particular feature is not explicitly illustrated or described with respect to each aspect of the present disclosure is not meant to be construed that it cannot be, but it is done for the sake of brevity and conciseness of the description. Thus, the various features of the different aspects may be mixed and matched as desired to form new aspects, whether or not the new aspects are expressly disclosed.

1. A glass comprising a plurality of components, the glass having a composition of the components comprising:
greater than or equal to 60.0 mol. % and less than or equal to 70.0 mol. % SiO₂,
greater than or equal to 5.0 mol. % and less than or equal to 20.0 mol. % Al₂O₃,
greater than or equal to 1.2 mol. % and less than or equal to 4.0 mol. % MgO,
greater than or equal to 0.5 mol. % and less than or equal to 10.0 mol. % Li₂O,
greater than or equal to 0.45 mol. % and less than or equal to 6 mol. % P₂O₅,
greater than or equal to 0.0 mol. % and less than or equal to 15.0 mol. % Na₂O,
greater than or equal to 0.0 mol. % and less than or equal to 5.0 mol. % B₂O₃,
greater than or equal to 0.0 mol. % and less than or equal to 1.0 mol. % ZnO,
greater than or equal to 0.0 mol. % and less than or equal to 0.5 mol. % K₂O,
less than or equal to 16.0 mol. % Alk₂O and
greater than or equal to 0.0 mol. % and less than or equal to 1.5 mol. % REₘOₙ,
wherein the glass satisfies the condition:
0.85≤Alk₂O/Al₂O₃ [mol. %]≤1.2, and
wherein:
chemical formulas mean the content of corresponding components in the glass in mol %,
Alk₂O is a total sum of alkali metal oxides, Li₂O+Na₂O+K₂O+Rb₂O+Cs₂O, and
REₘOₙ is a total sum of rare earth metal oxides, La₂O₃+Y₂O₃+Gd₂O₃+Yb₂O₃+Lu₂O₃+Ce₂O₃+Pr₂O₃+Nd₂O₃+Sm₂O₃+Eu₂O₃+Tb₂O₃+Dy₂O₃+Ho₂O₃+Er₂O₃+Tm₂O₃.

2. The glass of claim 1, wherein the glass that satisfies the condition:
0.9≤Alk₂O/Al₂O₃ [mol. %]≤1.1.

3. The glass of claim 1, wherein the glass satisfies the condition: 0.85≤Alk₂O/Al₂O₃ [mol. %]≤0.96.

4. The glass of claim 1, wherein the composition of the components comprises
greater than or equal to 12.0 mol. % and less than or equal to 18.0 mol. % Al₂O₃,
greater than or equal to 2.0 mol. % and less than or equal to 8.0 mol. % Li₂O,
greater than or equal to 0.45 mol. % and less than or equal to 4 mol. % P₂O₅,
greater than or equal to 0.3 mol. % and less than or equal to 15.0 mol. % Na₂O,
greater than or equal to 0 mol. % and less than or equal to 0.75 mol. % ZnO,
less than or equal to 15.5 mol. % Alk₂O and
greater than or equal to 0.0 mol. % and less than or equal to 0.3 mol. % REₘOₙ and
wherein the glass satisfies the condition:
0.85≤Alk₂O/Al₂O₃ [mol. %]≤1.09.

5. The glass of claim 1, wherein the composition of the components comprises
greater than or equal to 10.0 mol. % and less than or equal to 17.5 mol. % Al₂O₃,
greater than or equal to 0.5 mol. % and less than or equal to 7.5 mol. % Li₂O,
greater than or equal to 0.45 mol. % and less than or equal to 4 mol. % P₂O₅ and
greater than or equal to 0.3 mol. % and less than or equal to 15.0 mol. % Na₂O.

6. The glass of claim 1, wherein the composition of the components:
greater than or equal to 62.0 mol. % and less than or equal to 69.5 mol. % SiO₂,
greater than or equal to 11.5 mol. % and less than or equal to 16.5 mol. % Al₂O₃,
greater than or equal to 2.5 mol. % and less than or equal to 7.5 mol. % Li₂O,
greater than or equal to 2.0 mol. % and less than or equal to 11.5 mol. % Na₂O,
greater than or equal to 1.2 mol. % and less than or equal to 3.1 mol. % MgO,
greater than or equal to 0.45 mol. % and less than or equal to 3.7 mol. % P₂O₅,
greater than or equal to 0.4 mol. % and less than or equal to 4.6 mol. % B₂O₃,
greater than or equal to 0.1 mol. % and less than or equal to 0.9 mol. % ZnO,
greater than or equal to 0 mol. % and less than or equal to 0.95 mol. % CaO and
greater than or equal to 0 mol. % and less than or equal to 0.475 mol. % TiO₂.

7. The glass of claim 1, wherein the composition of the components comprises:
greater than or equal to 62.8 mol. % and less than or equal to 68.5 mol. % SiO₂,
greater than or equal to 12.2 mol. % and less than or equal to 15.8 mol. % Al₂O₃,
greater than or equal to 3.2 mol. % and less than or equal to 7.2 mol. % Li₂O,
greater than or equal to 3.0 mol. % and less than or equal to 10.5 mol. % Na₂O,
greater than or equal to 1.45 mol. % and less than or equal to 2.85 mol. % MgO,
greater than or equal to 0.8 mol. % and less than or equal to 4.0 mol. % B₂O₃,
greater than or equal to 0.8 mol. % and less than or equal to 3.3 mol. % P₂O₅,
greater than or equal to 0.200 mol. % and less than or equal to 0.825 mol. % ZnO,
greater than or equal to 0 mol. % and less than or equal to 0.85 mol. % CaO and
greater than or equal to 0 mol. % and less than or equal to 0.42 mol. % TiO₂.

8. The glass of claim 1, wherein the composition of the components comprises:
greater than or equal to 7.05 mol. % and less than or equal to 7.75 mol. % Li₂O.

9. The glass of claim 1, wherein the composition of the components comprises:
greater than or equal to 0.0 mol. % and less than or equal to 0.5 mol. % GeO₂,
greater than or equal to 0.0 at. % and less than or equal to 0.2 at. % Cl,
a sum of La₂O₃+Y₂O₃ is greater than or equal to 0.0 mol. % and less than or equal to 0.2 mol. %,
wherein the composition of the components is:
substantially free of arsenic,
substantially free of fluorine and
substantially free of PbO.

10. The glass of claim 1, wherein:
a sum of MgO+CaO+SrO+BaO+ZnO is greater than or equal to 0.0 mol. % and less than or equal to 10.0 mol. % and
(MgO+CaO+ZnO)/RO [mol. %]≥0.80.

11. The glass of claim 1, wherein the composition comprises the components, which concentrations
a sum of SiO₂+Al₂O₃+B₂O₃+P₂O₅+Li₂O+Na₂O+MgO is greater than or equal to 98.0 mol. %.

12. The glass of claim 1, wherein the glass has
Young's modulus, E that is greater than or equal to 70 GPa.

13. The glass of claim 1, wherein the glass has
decimal logarithm of liquidus viscosity, Log(η_{liq}, P) that is greater than or equal to 5.0 P.

14. The glass of claim 1, wherein the glass has
decimal logarithm of liquidus viscosity, Log(η_{liq}, P) that is greater than or equal to 5.1 P.

15. The glass of claim 1, wherein the glass has
decimal logarithm of liquidus viscosity, Log(η_{liq}, P) that is greater than or equal to 5.3 P.

16. A glass comprising a plurality of components, the glass having a composition of the components comprising
greater than or equal to 58.0 mol. % and less than or equal to 69.9 mol. % SiO₂,
greater than or equal to 3.0 mol. % and less than or equal to 10.0 mol. % Na₂O,
greater than or equal to 3 mol. % and less than or equal to 7.95 mol. % Li₂O,
greater than or equal to 1.0 mol. % and less than or equal to 20.0 mol. % Al₂O₃,
greater than or equal to 0.0 mol. % and less than or equal to 4.8 mol. % MgO,
greater than or equal to 0.0 mol. % and less than or equal to 4.0 mol. % ZnO,
greater than or equal to 0.0 mol. % and less than or equal to 2.5 mol. % CaO,
greater than or equal to 0.0 mol. % and less than or equal to 1.0 mol. % TiO₂,
greater than or equal to 0.0 mol. % and less than or equal to 1.0 mol. % ZrO₂,
greater than or equal to 0.0 mol. % and less than or equal to 0.5 mol. % SnO₂,
greater than or equal to 0.0 mol. % and less than or equal to 0.5 mol. % BaO,
greater than or equal to 0.0 mol. % and less than or equal to 0.5 mol. % K₂O,
greater than or equal to 9.0 mol. % and less than or equal to 17.5 mol. % Alk₂O,
greater than or equal to 0.0 mol. % and less than or equal to 1.5 mol. % REₘOₙ,
a sum of Li₂O+Na₂O is greater than or equal to 12.0 mol. % and less than or equal to 17.5 mol. %,
wherein the glass satisfies the conditions:
0.50≤Li₂O/Alk₂O [mol. %]≤0.55 and
0.85≤Alk₂O/Al₂O₃ [mol. %]≤1,
Pₒₓ−(1.5+P_{RO})<0.000, and
P_{RO} greater than or equal to −2 and less than or equal to 2
wherein
P_{RO} is a value of RO balance parameter, calculated from the glass composition in terms of mol. % of the components according to the following formula:
P_{RO}=(MgO+CaO+ZnO)−(B₂O₃+P₂O₅),
Pₒₓ is a value of oxygen balance parameter, calculated from the glass composition in terms of mol. % of the components according to the following formula:
Pₒₓ=(Alk₂O+RO)−(Al₂O₃+P₂O₅),
chemical formulas mean the content of corresponding components in the glass in mol %,
Alk₂O is a total sum of alkali metal oxides, Li₂O+Na₂O+K₂O Rb₂O+Cs₂O, and
REₘOₙ is a total sum of rare earth metal oxides, La₂O₃+Y₂O₃+Gd₂O₃+Yb₂O₃+Lu₂O₃+Ce₂O₃+Pr₂O₃+Nd₂O₃+Sm₂O₃+Eu₂O₃+Tb₂O₃+Dy₂O₃+Ho₂O₃+Er₂O₃+Tm₂O₃, and
RO is the total sum of MgO+CaO+SrO+BaO+ZnO.

17. The glass of claim 16, wherein the glass satisfies the conditions:
Pₒₓ−(0.5+P_{RO})<0.000,
wherein
Pₒₓ is a value of oxygen balance parameter, calculated from the glass composition in terms of mol. % of the components according to the following formula:
Pₒₓ=(Alk₂O+RO)−(Al₂O₃+P₂O₅),
P_{RO} is a value of RO balance parameter, calculated from the glass composition in terms of mol. % of the components according to the following formula:
P_{RO}=(MgO+CaO+ZnO)−(B₂O₃+P₂O₅).

18. The glass of claim 16, wherein the composition of the components comprises:
greater than or equal to 60.0 mol. % and less than or equal to 69.9 mol. % SiO₂,
greater than or equal to 12.0 mol. % and less than or equal to 18.0 mol. % Al₂O₃,
greater than or equal to 1.2 mol. % and less than or equal to 4.0 mol. % MgO,
greater than or equal to 0.3 mol. % and less than or equal to 4.0 mol. % P₂O₅,
greater than or equal to 0.0 mol. % and less than or equal to 5.0 mol. % B₂O₃,
greater than or equal to 0 mol. % and less than or equal to 0.75 mol. % ZnO,
less than or equal to 15.5 mol. % Alk₂O and
greater than or equal to 0.0 mol. % and less than or equal to 0.3 mol. % REₘOₙ.

19. The glass of claim 16, wherein the glass that satisfies the condition:
0.85≤Alk₂O/Al₂O₃ [mol. %]≤0.96.

20. The glass of claim 16, wherein the composition of the components comprises
greater than or equal to 60.0 mol. % and less than or equal to 69.9 mol. % SiO₂,
greater than or equal to 12.0 mol. % and less than or equal to 18.0 mol. % Al₂O₃,
greater than or equal to 1.2 mol. % and less than or equal to 4.0 mol. % MgO,
greater than or equal to 0.3 mol. % and less than or equal to 4.0 mol. % P₂O₅,
greater than or equal to 0.0 mol. % and less than or equal to 5.0 mol. % B₂O₃,
greater than or equal to 0 mol. % and less than or equal to 0.75 mol. % ZnO,
less than or equal to 15.5 mol. % Alk₂O and
greater than or equal to 0.0 mol. % and less than or equal to 0.3 mol. % REₘOₙ.
